(19) United States
(12) Patent Application Publication
(10) Pub. No.: US 2008/0225421 A1
(43) Pub. Date: Sep. 18, 2008

(54) COMPOUND AUTOMOTIVE REARVIEW MIRROR

(76) Inventor: George E. Platzer, Rochester Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/054,960

(22) Filed: Mar. 25, 2008

Related U.S. Application Data
(62) Division of application No. 10/280,042, filed on Oct. 24, 2002, now abandoned.
Application No. 10/280,042 is a continuation-in-part of application No. PCT/US01/13283, filed on Apr. 24, 2001.
Application No. PCT/US01/13283 is a continuation of application No. 09/551,676, filed on Apr. 24, 2000, now Pat. No. 6,315,419.
Application No. 09/551,676 is a continuation of application No. 09/733,410, filed on Dec. 11, 2000, now abandoned.

(51) Int. Cl. B60R 1/08

(52) U.S. Cl. 359/864

(57) ABSTRACT

A composite mirror adapted for use as an outside rearview mirror of a motor vehicle includes a main or primary viewing mirror and an auxiliary blindzone viewing mirror juxtaposed to expose the vehicle blindzone to the vehicle operator. The main viewing mirror is generally of unit magnification. The auxiliary mirror is composed of a planar array of reflecting facets mimicking a convex mirror. The main and auxiliary mirrors can be combined in constant or variable reflectivity applications.

### CROSS-REFERENCE TO RELATED APPLICATION

This application is a divisional of U.S. patent application Ser. No. 10/280,042, filed Oct. 24, 2002, which is a continuation-in-part of International Application Serial No. PCT/US01/13283, filed on Apr. 24, 2001, that designates the United States of America and was published under PCT Article 21(2) in English, which is a continuation of U.S. patent application Ser. No. 09/551,676, filed Apr. 24, 2000, now issued as U.S. Pat. No. 6,315,419 on Nov. 13, 2001, and U.S. patent application Ser. No. 09/733,410, filed Dec. 11, 2000, now abandoned.

### BACKGROUND OF THE INVENTION

1. Field of the Invention

The present invention relates generally to mirrors having multiple surfaces of differing magnification and, particularly, to the application of such mirrors as external side rearview automotive operator aides.

2. Background Art

Originally, motor vehicles, particularly passenger cars, did not have mirrors to assist the driver. Early in this century however, both inside and outside mirrors were added to automotive vehicles to provide rearward and limited lateral visibility. As the number of vehicles and driving speeds increased, rearward visibility became ever more important.

Today, all passenger cars have a mirror centrally located inside the vehicle. This mirror is the primary mirror. It provides a wide viewing angle, giving an excellent view to the adjacent lanes at a distance of two or more car lengths to the rear. However, it is deficient in that it is unable to view the adjacent lanes at distances of less than one to two car lengths to the rear. In an effort to eliminate this deficiency and to provide rearward visibility when the rear window is blocked, outside mirrors were added to vehicles.

Presently, passenger cars are required by law to have a unit magnification outside rearview mirror on the driver's side. A unit magnification mirror is a plane mirror which produces the same size image on the retina as that which would be produced if the object were viewed directly from the same distance. Furthermore, as provided in Federal Motor Vehicle Safety Standard 111 (FMVSS 111), “The mirror shall provide the driver a field of view of a level road surface extending to the horizon from a line perpendicular to a longitudinal plane tangent to the driver's side of the vehicle at the widest point, extending 8 feet out from the tangent plane 35 feet behind the driver's eyes, with the seat in the rear most position.” FMVSS 111 thus effectively determines the size of the mirror, which a manufacturer must provide. The size will vary among different manufacture's vehicles because of the placement of the mirror on the vehicle with regard to the driver's seat location.

Unfortunately, outside mirrors meeting FMVSS 111 still do not provide adequate adjacent lane visibility to view cars that are in the range of one car length to the rear. That is, a blindzone exists where a vehicle is not visible in either the inside mirror or the outside mirror. Even a glance over the shoulder may not be adequate to observe a vehicle in the blindzone. For many vehicles, the door pillar between the front and rear doors obscures the view to the blindzone. Furthermore, this obstruction is not obvious to most drivers, and they may assume that the “over the shoulder glance” has allowed them to see the blindzone when in reality it has not.

Rearward vision in automobiles is mathematically described in a paper published by the Society of Automotive Engineers (SAE) in 1995. That paper is designated as SAE Technical Paper 950601. It is entitled, The Geometry of Automotive Rearview Mirrors—Why Blindzones Exist and Strategies to Overcome Them, by George Platzer, the inventor of the present invention. That paper is hereby incorporated by reference.

A common method of overcoming the blindzone is to add a spherically convex blindzone-viewing mirror to the required plane main mirror. Spherically convex mirrors provide a wide field of view, but at the penalty of a reduced image size. However, this may be acceptable if the mirror is only used to indicate the presence of a vehicle in the blindzone and it is not used to judge the distance or approach speed of vehicles to the rear. Simply placing a round segment of a convex mirror on the main mirror surface, as is commonly done with stick-on convex mirrors, does not solve the problem. Doing so can provide a view to the rear which includes the blindzone, but it will also show much of the side of the car, the sky and the road surface, which are distracting and extraneous to the safe operation of the vehicle. What is required is a convex blindzone-viewing mirror that shows the driver primarily only the blindzone. In this way, if the driver sees a vehicle in the blindzone-viewing mirror, he knows it is unsafe to move into the adjacent lane. All extraneous and distracting information should be removed from the blindzone-viewing mirror. Furthermore, by eliminating the irrelevant portions of the bull's-eye mirror, the remaining portion can have a larger radius of curvature, thereby increasing the image size for the given amount of area that is to be allocated to the convex mirror.

Other problems with add-on mirrors are that they:
may interfere with the requirements of FMVSS 111;
may substantially decrease the plane main mirror viewing angle;
interfere with cleaning, especially when there is ice on it; and
appear as an unsightly excrescence on the main mirror. A blindzone-viewing mirror that is provided by a car manufacturer must not appear to be an afterthought, but rather an integral part of the mirror.

### SUMMARY OF THE INVENTION

One object of the present invention is to provide a unit magnification main mirror, which meets the requirements of FMVSS 111 and simultaneously provides a blindzone-viewing mirror having a magnification of less than unity that, in application, is able to show an automobile driver's side blindzone.

Another object of the invention is to provide a less than unit magnification mirror that meets the requirements of FMVSS 111 on the passenger's side and simultaneously provides a blindzone-viewing mirror having a magnification of less than unity that is able to show the driver the blindzone on the passenger's side.

Yet another object of the invention is to provide a mirror having a combination of two surfaces of different magnification that is not objectionable in appearance.

Still another object of the invention is to provide a mirror having a combination of two surfaces of different magnification that is inexpensive and easy to manufacture.

In a preferred embodiment of the invention, a less than unit magnification mirror is located in the upper and outer region of a unit magnification mirror, and it is optimized in size and orientation to provide primarily only a view of the blindzone while leaving the region surrounding it available to meet the requirements of FMVSS 111. The less than unit magnification mirror is integral with the unit magnification mirror.

In another preferred embodiment of the invention, the less than unit magnification mirror is a discrete component physically attached to the unit magnification main mirror.

In yet another preferred embodiment of the invention, the unit magnification main mirror includes means operative to selectively vary the intensity of the reflection from the main mirror while maintaining a relatively fixed reflection intensity characteristic of the auxiliary mirror.

### BRIEF DESCRIPTION OF THE DRAWINGS

In the drawings, wherein for clarity certain detail may be omitted from one or more views:

FIG. 1 is a plan view of an automobile on a three-lane highway depicting the field of view of the outside mirrors and the blindzones;

FIG. 2 is a diagram showing the requirements of FMVSS 111 for the horizontal field of view of the driver's outside mirror;

FIG. 3 is a diagram showing the requirements of FMVSS 111 for the vertical field of view of the driver's outside mirror;

FIG. 4 is an image of the road as seen in the driver's outside mirror showing the effect of the requirements of FMVSS 111 on the horizontal width and the vertical height of the mirror;

FIG. 5 is a perspective drawing showing how a less than unit magnification mirror can be placed on the driver's outside mirror to avoid conflicting with the requirements of FMVSS 111 and yet provide a wide angle mirror to observe the blindzone;

FIG. 6 is a front view of the mirror of FIG. 5;

FIG. 7 is side sectional view of the mirror of FIG. 6 in the plane along line 7-7 in the direction of the arrows showing the proper location of the center of the sphere on which the surface of the blindzone mirror lies, so as to produce vertical centering of the image of a vehicle that is in the blindzone;

FIG. 8 is a top sectional view of the mirror of FIG. 6 in the plane along line 8-8 looking in the direction of the arrows showing the proper location of the center of the sphere on which the surface of the blindzone mirror lies, so as to produce horizontal centering of the image of a vehicle that is in the blindzone;

FIG. 9 is a plan view of a two-lane highway showing a vehicle in the right lane equipped with the mirror of FIG. 5 and four positions of an overtaking vehicle in the left lane;

FIG. 10a shows the image of an overtaking vehicle in FIG. 9, in a mirror like that of FIG. 5;

FIG. 10b is like FIG. 10a except that the overtaking vehicle is farther to the rear;

FIG. 10c is like FIG. 10b except that the overtaking vehicle is farther to the rear;

FIG. 10d is like FIG. 10c except that the overtaking vehicle is farther to the rear;

FIG. 11 is a front view of a driver's side mirror embodying the teachings of this invention;

FIG. 12 is an enlarged top sectional view of the mirror of FIG. 11 taken in the plane along line 12-12 in the direction of the arrows.

FIG. 13 is a top view of a circular segment of a spherical mirror;

FIG. 14 is a side view of the mirror of FIG. 13;

FIG. 15 is a top view of the mirror of FIG. 13 wherein the mirror has been cut into square elements;

FIG. 16 is a side sectional view of the mirror of FIG. 15 taken in the plane along line 16-16 looking in the direction of the arrows;

FIG. 17 depicts how the mirror of FIGS. 15 and 16 can be rearranged into a planar array of reflecting facets;

FIG. 18 shows how light is reflected from the mirror of FIG. 14;

FIG. 19 shows how light reflected from the mirror of FIG. 17 simulates the reflections from the mirror of FIG. 14;

FIG. 20 shows a mirror alternatively embodying the teachings of the invention;

FIG. 21 is an enlarged side sectional view of the mirror of FIG. 20 taken in the plane along line 21-21 and looking in the direction of the arrows;

FIG. 22 is a diagram comparing a directly reflected ray from a front surface mirror to a refracted ray from a second surface mirror;

FIG. 23 is a diagram comparing the radius of curvature of a front surface mirror to the radius of curvature of a second surface mirror;

FIG. 24 shows another embodiment of a mirror using the teachings of the invention;

FIG. 25 shows an enlarged top sectional view of the mirror of FIG. 24 in the plane along line 25-25 looking in the direction of the arrows;

FIG. 26 shows yet another embodiment of a mirror employing the teachings of the invention;

FIG. 27 is an enlarged top sectional view of the mirror of FIG. 26 in the plane along line 27-27 looking in the direction of the arrows;

FIG. 28 shows still another embodiment of a mirror employing the teachings of the invention;

FIG. 29 is an enlarged top sectional view of the mirror of FIG. 28 in the plane along line 29-29 and looking in the direction of the arrows;

FIG. 30 shows another embodiment of a mirror using the teachings of the invention;

FIG. 31 is an enlarged top sectional view of the mirror of FIG. 30 taken in the plane along line 31-31 looking in the direction of the arrows;

FIG. 32 shows yet another mirror embodying the teachings of this invention;

FIG. 33 is an enlarged top sectional view of the mirror of FIG. 32 taken in the plane along line 33-33 and looking in the direction of the arrows;

FIG. 34 shows another mirror incorporating the teachings of the invention;

FIG. 35 shows still another mirror incorporating the teachings of the invention;

FIG. 36 is a front view of a prior art mirror having variable reflectivity;

FIG. 37 is a top sectional view of the mirror of FIG. 36 in the plane along line 37-37 looking in the direction of the arrows;

FIG. 38 is a front view of a variable reflectivity mirror embodying the present invention;

FIG. 39a is a top sectional view of the mirror of FIG. 38 in the plane along line 39-39 looking in the direction of the arrows;

FIG. 39b shows another embodiment of a variable reflectivity mirror employing the teachings of the present invention similar in a number of respects to the embodiment of FIG. 39a;

FIG. 40 is a front view of an alternative embodiment variable reflectivity mirror;

FIG. 41 is a top sectional view of the mirror of FIG. 40 in the plane along line 41-41 looking in the direction of the arrows;

FIG. 42 is a front view of another alternative embodiment variable reflectivity mirror;

FIG. 43 is a top sectional view of the mirror of FIG. 42 in the plane along line 43-43 looking in the direction of the arrows;

FIG. 44 is a front view of another alternative embodiment variable reflectivity mirror similar in a number of respects to the embodiment of FIGS. 42 and 43;

FIG. 45 is a top sectional view of the mirror of FIG. 44 in the plane along line 45-45 looking in the direction of the arrows;

FIG. 46 is a front view of another alternative embodiment variable reflectivity mirror;

FIG. 47a is a broken, top sectional view of the mirror of FIG. 46 on an enlarged scale in the plane along line 47-47 looking in the direction of the arrows;

FIG. 47b shows another embodiment of a variable reflectivity mirror similar in a number of respects to the embodiment of FIG. 47a;

FIG. 47c shows yet another embodiment of the variable reflectivity mirror similar in a number of respects to the embodiment of FIG. 47a;

FIG. 48 is a front view of another alternative embodiment variable reflectivity mirror similar in a number of respects to the embodiment of FIGS. 46 and 47a;

FIG. 49 is a top sectional view of the mirror of FIG. 48 in the plane along line 49-49 looking in the direction of the arrows;

FIG. 50 is a front view of another alternative embodiment variable reflectivity mirror similar in a number of respects to the embodiment of FIGS. 46 and 47c;

FIG. 51 is a top sectional view of the mirror of FIG. 50 in the plane along line 51-51 looking in the directions of the arrows;

FIG. 52 is a front view of yet another alternative embodiment variable reflectivity mirror;

FIG. 53 is a top sectional view of the mirror of FIG. 52, in the plane along line 53-53 looking in the direction of the arrows;

FIG. 54 is an exploded perspective view of the mirror of FIG. 52;

FIG. 55 is a front view of another embodiment of a mirror employing the teachings of this invention;

FIG. 56 is an enlarged sectional view of the mirror of FIG. 55 taken along section line 56-56 in the direction of the arrows;

FIG. 57 is an exploded view of a mirror assembly of the present invention;

FIG. 58 is a cross-sectional side view of a mirror and bezel;

FIG. 59 is a front view of a unitary mirror structure embodying the present invention;

FIG. 60 is an enlarged top sectional view of the mirror of FIG. 59 taken along line 60-60;

FIG. 60a is an enlarged view of a region of the first surface of the mirror of FIG. 60;

FIG. 61 is an enlarged side sectional view of the mirror of FIG. 59 taken along line 61-61;

FIG. 62 is an enlarged side sectional view of the mirror of FIG. 59 taken along line 62-62;

FIG. 63 is a perspective view of the mirror of FIG. 59 rotated to best show the mirror's form;

FIG. 64 is a front view of an alternative embodiment of the unitary mirror structure;

FIG. 65 is an enlarged top sectional view of the mirror of FIG. 64 taken along line 65-65;

FIG. 66 is a perspective view of the mirror of FIG. 64 rotated in such a way to best show the mirror's form;

FIG. 67 is a front view of yet another alternative embodiment of the unitary mirror structure;

FIG. 68 is an enlarged top sectional view of the mirror of FIG. 67 taken along line 68-68;

FIG. 69 is an enlarged side sectional view of the mirror of FIG. 67 taken along line 69-69;

FIG. 70 is an enlarged side sectional view of the mirror of FIG. 67 taken along line 70-70;

FIG. 71 is a perspective view of the mirror of FIG. 67;

FIG. 72 is a front view of a discrete mirror body in the shape of a square embodying the teachings of this invention;

FIG. 73 depicts how the mirror of FIG. 72 can be truncated to fit conveniently in an upper and outer quadrant of an automotive outside rearview mirror;

FIG. 74 depicts how the mirror of FIG. 73 can be contoured to precisely fit a given automotive outside rear view mirror;

FIG. 75 is a front view of a preferred embodiment of a discrete mirror body employing the teachings of this invention;

FIG. 76 is perspective drawing of a discrete mirror body attached to a plane main mirror when viewed from an angle similar to that of the driver;

FIG. 77 is a bottom view of the mirror of FIG. 75 showing an application of a canted inboard edge of the mirror;

FIG. 78 is a bottom view of the mirror of FIG. 75 showing an alternative application of the canted inboard edge of the mirror;

FIG. 79 is a bottom sectional view of the mirror of FIG. 75 taken along line 79-79;

FIG. 80 is a sectional view of an alternative embodiment of a discrete mirror body employing the teaches of this invention; and

FIG. 81 is a sectional view of yet another alternative embodiment of a discrete mirror body employing the teachings of this invention.

### DETAILED DESCRIPTION OF THE PREFERRED EMBODIMENT(S)

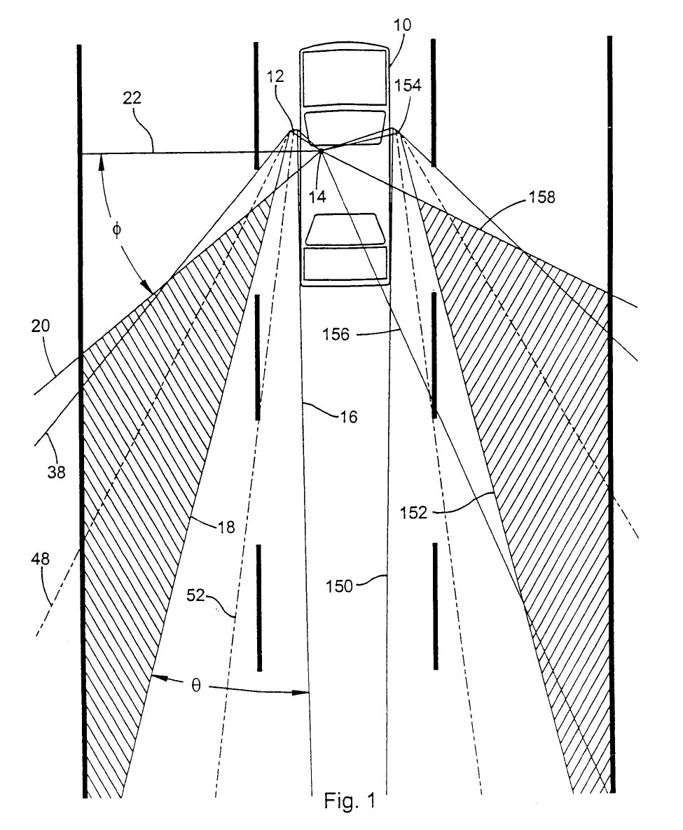

Referring now in greater detail to the drawings, FIG. 1 shows a mid-sized passenger car 10 in the middle lane of a three-lane highway with 12-foot wide lanes. The vehicle 10 is equipped with a driver's side outside mirror 12. The driver's eyes are shown centered at point 14, from which the driver has a field of view to the rear in the horizontal plane encompassing the acute angle formed by lines 16 and 18. Line 20 defines the rearward limit of the driver's peripheral vision when looking at mirror 12. Thus, the area bounded by lines 18 and 20 is a blindzone, shown crosshatched, which cannot be observed in either the driver's direct forward vision or indirectly in the mirror.

SAE Technical Paper 950601 describes the horizontal field of view of a plane mirror in a mathematical equation as a function of the mirror's dimensions and the position of the eyes relative to the mirror. Typically, the angle subtended by lines 16 and 18 is in the order of 15° to 20°. Angle θ is given by Eq. 1, and it is,

$$θ = 2 {tan}^{- 1} [ \frac{w cos λ + D}{2 \sqrt{{S}_{L}^{2} + {S}_{T}^{2}}} ] , \qquad Eq . 1$$

where:
w=mirror width;
D=interpupillary distance;
S_{L}=the longitudinal distance along the axis of the vehicle form the driver's eyes to the center of the mirror;
S_{T}=the transverse distance perpendicular to the longitudinal axis from the driver's eyes to the center of the mirror; and
λ=½ tan⁻¹(S_{T}/S_{L}).

As described in SAE Technical Paper 950601, the peripheral vision line 20 cannot be precisely located. It depends on the location of the drivers' eyes relative to the mirror 12 and several other factors. For example, Burg (Journal of Applied Psychology, Vol. 5, No. 12, 1968) has shown that the angular extent of peripheral vision is a function of age. At age 20 it extends 88° from straight-ahead to the side. At 70 years, this angle has dropped to 75°.

Angle φ in FIG. 1 is the angle of the peripheral vision line 20 relative to line 22, which is perpendicular to the longitudinal axis of vehicle 10. Typically this angle will be in the range of 40 degrees.

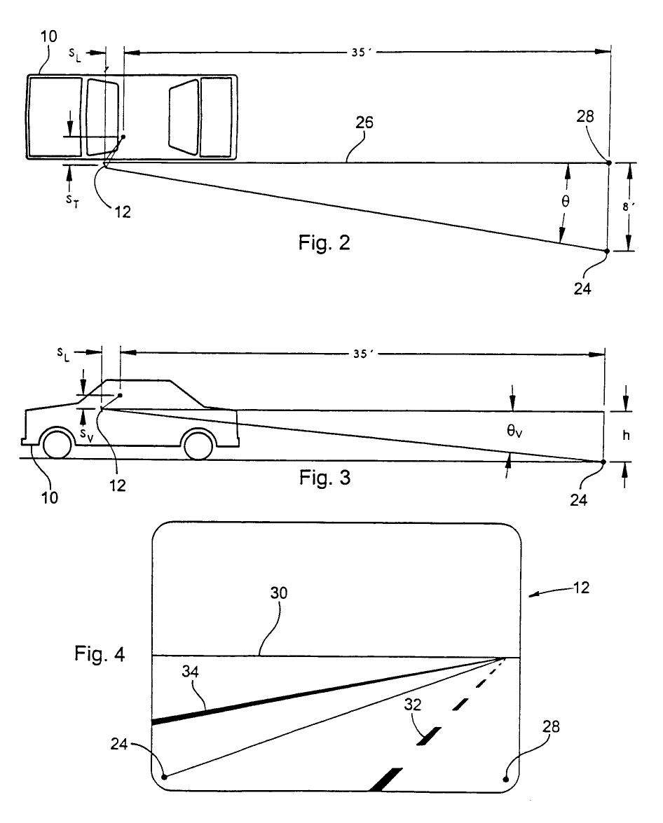

FIG. 2 shows the requirement imposed on the width of mirror 12 by FMVSS 111. As previously stated, the mirror 12 must be able to show a point, as 24, which is 244 cm (8 feet) out from a plane 26 tangent to the side of the vehicle and 1067 cm (35 feet) behind the driver's eyes with the seat in the rear most position. Point 28 is 1067 cm behind the driver's eyes and in plane 26. Points 24 and 28 are on the road surface. Angle θ in FIG. 2 is obviously,

$$θ = {tan}^{- 1} ( \frac{244}{{S}_{L} + 1067} ) . \qquad Eq . 2$$

Angle θ has a value of about 11.5° for almost any passenger car, and the variation in θ produced by variations in S_{L} is a second order effect. Hence, the width of the mirror required by FMVSS 111 can be calculated by solving Equation 1 for w. Then,

$$w = \frac{2 \sqrt{{S}_{L}^{2} + {S}_{T}^{2}} ( tan \frac{θ}{2} ) - D}{cos λ} . \qquad Eq . 3$$

Angle θ in this case is equal to 11.5°. Using values of S_{L}=45.7 cm, S_{T}=70 cm, and D=6.4 cm, w is found to be 9.4 cm. This value can vary significantly among vehicles, since in Eq. 3, S_{L} and S_{T} variations no longer produce only second order effects as in Eq. 2. In practice, vehicle manufactures will specify mirror widths in excess of the FMVSS 111 requirements to further reduce the blindzone size.

FIG. 3 shows the requirements imposed on the vertical dimension of mirror 12 by FMVSS 111. In the vertical plane, vision is monocular since the eyes are not separated as they are in the horizontal plane. SAE Technical Paper 950601 shows that for monocular vision, the interpupillary distance D drops out of Equation 1, so that it becomes,

$$θ = 2 {tan}^{- 1} [ \frac{w cos λ}{2 \sqrt{{S}_{L}^{2} + {S}_{T}^{2}}} ] . \qquad Eq . 4$$

### Then,

$$w = \frac{2 \sqrt{{S}_{L}^{2} + {S}_{T}^{2}} ( tan \frac{θ}{2} )}{cos λ} . \qquad Eq . 5$$

In FIG. 3, h is the height in cm of mirror 12 above the ground, and it can vary significantly from a sports car to a sedan to a van. Angle θ_{V} is the angle that determines what the vertical dimension, Wᵥ, of mirror 12 must be, in conjunction with the distance of the eye from the mirror. Angle θ_{V} replaces angle θ in Equation 5 when calculating the vertical dimension of the mirror. Applying Equation 5 to the required vertical dimension of the mirror, wᵥ,

$${w}_{V} = \frac{2 \sqrt{{S}_{L}^{2} + {S}_{V}^{2}} ( tan \frac{{θ}_{V}}{2} )}{cos {λ}_{V}} , \qquad Eq . 6$$

where:
Sᵥ=vertical distance in the vertical plane from the eye to the mirror;
λ_{V}=½ tan⁻¹(S_{V}/S_{L}); and

$${λ}_{V} = {tan}^{- 1} ( \frac{h}{{S}_{V} + 1067} ) .$$

Substituting measured values of h, S_{L}, and S_{V} from one mid-size passenger car gave a value for wᵥ of 6.4 cm.

The FMVSS 111 requirement for the vertical dimension of the mirror is only a minimum, and it does not provide a satisfactory mirror. Drivers usually set their mirrors so that if the car is on a straight and level road, the horizon will be in about the center of the mirror. This means that if point 24 is to be visible with the horizon centered, the mirror should be about 12.7 cm high. Most passenger car mirrors are not this large vertically, and are closer to 10.2 cm to 11.4 cm. However, the requirements of the standard are met.

FIG. 4 shows mirror 12 adjusted so that the horizon 30 lies at its center. Point 24 is shown in the lower left-hand corner. Also shown is point 28 in the right-hand corner. Line 32 represents the dashed yellow lane marker between the two left lanes. Line 34 represents the left edge of the left lane. Lines 32 and 34 converge at infinity on the horizon. The mirror has been adjusted so that point 28 is just visible, i.e. rotating the mirror farther outward would make point 28 disappear from view.

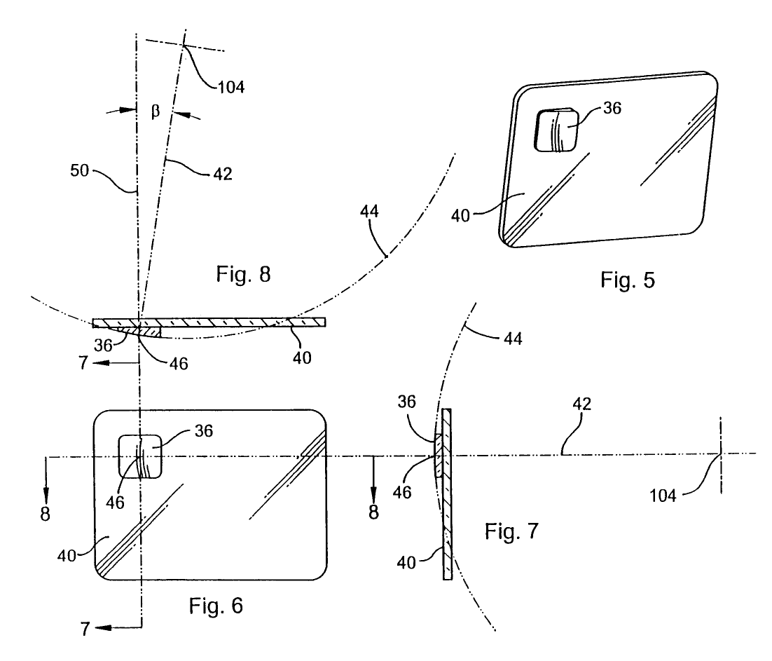

As previously mentioned, a mirror constructed to just meet the requirement in its horizontal field of view would have an excessively large blindzone. This could be remedied by providing an auxiliary blindzone-viewing mirror of less than unit magnification with a wide field of view, located such that it does not interfere with line 34. Such an auxiliary mirror 36 is shown in FIG. 5 attached to a plane main viewing mirror 40. Mirror 36 is a spherically convex mirror having dimensions and an orientation such that its field of view encompasses the region in FIG. 1 between lines 18 and 38. Mirror 36 can be made small enough so that is does not excessively encroach on the plane area of the main viewing mirror 40 above line 34. For example, if mirror 40 is 10 cm wide, mirror 36 could easily be 4.4×4.4 cm square. Using 4.4 cm as the horizontal dimension for mirror 36, the radius of curvature required to encompass the blindzone can be calculated from another equation in SAE Technical Paper 950601. There it is shown that the field of view of a convex mirror is,

$$θ = 2 [ 2 {tan}^{- 1} \frac{w}{2 r} + {tan}^{- 1} \frac{w cos λ + D}{2 \sqrt{{s}_{L}^{2} + {s}_{T}^{2}}} ] \qquad Eq . 7$$

All of the variables in Equation 7 are the same as Equation 1 except for r, which is the radius of curvature of the convex mirror. Angle θ in Equation 7 is to be taken as the angle between lines 18 and 38 in FIG. 1. Line 38 is seen to extend from mirror 12 and intersect the peripheral vision line 20 in the center of the adjacent lane. The angle between lines 18 and 38 is about 25°. Using w=4.5 cm, S_{L}=46.0 cm, S_{T}=61.0 cm and D=6.4 cm, r calculates out to be 29.9 cm. Selection of 25° as the blindzone width is partially subjective. It involves the choice of the peripheral vision angle, the positioning of the mirror and an estimate of how much of the geometrically defined blindzone must be included to assure that a driver is able to see a vehicle in the blindzone. In general a radius of curvature in the range of 20 cm to 35 cm will be satisfactory depending upon the vehicle.

A key factor in the shaping and positioning of the blindzone-viewing mirror is the required location of the center of the sphere from which the segment is taken. A vehicle in the blindzone should appear centered in the auxiliary blindzone-viewing mirror. FIGS. 6, 7 and 8 comprise a geometric orthographic projection showing the proper orientation of a spherically convex mirror segment 36 relative to a plane mirror 40. A radius 42 and an arc 44 of the sphere from which segment 36 is taken, must pass through the center 46 of the face of segment 36. The location of the center of the sphere must be specified so that centering of the image of a vehicle in the blindzone will occur.

As previously stated, most drivers adjust their mirrors so that if they were on a straight and level road, the horizon would be approximately centered in the mirror. Vertical centering of an image in the blindzone-viewing mirror 36 then requires that the image of the horizon pass through center 46 of mirror 36. This simply requires that radius 42 lie in a plane perpendicular to plane mirror 40, and that the plane also pass through center point 46, as shown in FIG. 7.

Horizontal centering of the view of the blindzone in mirror 36 requires that radius 42 be located such that it passes through center 46 of mirror 36 and also falls along line 48 in FIG. 1 which bisects the acute angle formed by lines 18 and 38. The actual position of radius line 42 in FIG. 8 relative to the vehicle is dependent upon how the driver has positioned the mirror relative to the vehicle. However, the position of line 42 relative to line 50 in FIG. 8 is constant. If the driver is instructed to position the plane mirror so that the side of the car is just visible, the position of line 42 is then effectively constant relative to the side of the vehicle, and the blindzone view is effectively centered about line 48 in FIG. 1.

The field of view in the plane main viewing mirror is 0 degrees wide as shown in FIG. 1. If the driver so chooses, he or she could readjust the main viewing mirror so angle θ straddles line 48. Then, the plane mirror view would be centered on the blindzone. Many drivers actually set their mirrors this way to view the blindzone. Since the angle of reflection is equal to the angle of incidence, rotating the field of view outward by say 30°, would require rotating the mirror outward by 15°. Hence, to make the plane mirror look into the center of the blindzone requires that it be rotated by ½ of the angle between line 48 and line 52, where line 52 bisects angle θ. Again selecting the blindzone width as 25°, and using a value of 15° for θ, the field of view would have to be rotated ½ (25°±15°)=20°. This would require rotating the mirror 10° to look into the center of the blindzone with the plane mirror.

The same reasoning applies to the convex blindzone-viewing mirror. If radius 42 were perpendicular to the surface of plane mirror 40, the field of view of the convex mirror would be centered about line 52 in FIG. 1. But we want the spherical mirror's field of view to be centered about line 48 when the plane mirror is adjusted to just see the side of the vehicle. Therefore in FIG. 8, line 42 should be at an angle of 10° to line 50. The exact angle chosen will be dependent upon the vehicle and the assumptions made for the position of line 48 in FIG. 1.

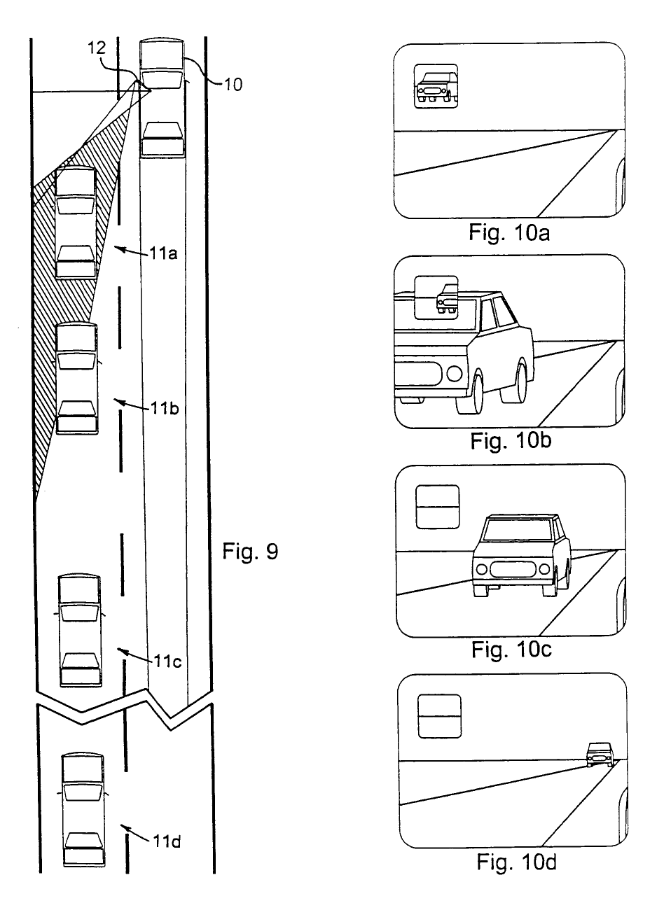

The criteria required to size, place and orient the less than unit magnification auxiliary blindzone-viewing mirror have now been established. Using these criteria will provide a mirror which conforms with FMVSS 111, centers the image of a vehicle in the blindzone in the less than unit magnification mirror, and optimizes the image size for the space allocated to the less than unit magnification mirror. Mirror 36 in FIG. 5 may be visualized as a spherically convex bull's-eye mirror wherein all extraneous portions of the bull's-eye have been removed, leaving only that portion which will show a vehicle in the blindzone. When driving with a mirror so configured, a vehicle overtaking on the driver's side will be seen in the main viewing mirror when the vehicle is to the rear of the blindzone. As the vehicle approaches, it appears to slide outwardly off of main viewing mirror 40 and onto blindzone-viewing mirror 36. FIG. 9 shows an overtaking vehicle at various distances behind vehicle 10 of FIG. 1. FIGS. 10a, 10b, 10c and 10d show the position of the image of the overtaking vehicle on mirror 12 in FIG. 9. Note that a small portion of the left rear fender of vehicle 10 is seen in the lower right-hand corner of the plane main mirror. FIG. 10d shows the image of the overtaking vehicle at a position 11d in FIG. 9 about 12 car lengths to the rear of vehicle 10. FIG. 10c shows the image of the vehicle at a position 11c about 3.5 car lengths to the rear. FIG. 10b shows the image of the vehicle at position 11b about 1.25 car length back, and it is seen mostly in the plane main viewing portion of the mirror, but partially in the auxiliary blindzone-viewing portion. FIG. 10a shows the image of the overtaking vehicle in position 11a, which is entirely in the blindzone, and it is seen that the image is entirely in the blindzone-viewing mirror. Thus, the image of the approaching vehicle moves from inside to outside across the mirror, and this is one reason why the auxiliary mirror is placed in the upper and outer quadrant of the rearview mirror. Placing it on the inner quadrant would disturb the apparent flow of the image of the overtaking vehicle as it moves across the main mirror from inside to outside.

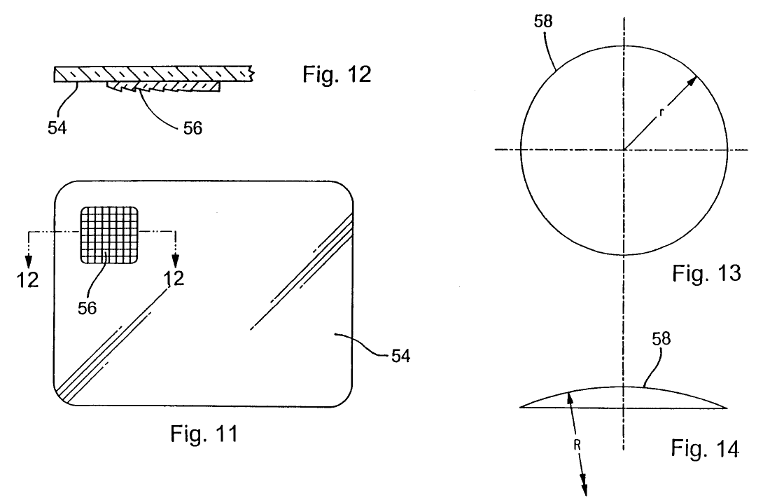

Next, various ways of implementing the combination of the main viewing mirror and the blindzone-viewing mirror will be shown. One simple way is to adhere a glass or plastic segment of a spherically convex mirror to the plane mirror as shown in FIG. 5. However, the stick-on mirror is objectionable in its appearance, its vulnerability to damage, and its interference with cleaning the mirror. It would be highly desirable to reduce its protrusion above the surface of the main mirror. One way of doing this is shown in FIGS. 11 and 12. FIG. 11 is a front view of a plane mirror 54 to which an auxiliary blindzone-viewing mirror 56 has been adhered. Mirror 56 is a planar array of small square reflecting facets that simulate the reflection from a segment of a spherically convex mirror such as the auxiliary blindzone-viewing mirror 36 in FIG. 5. As will be shown, the planar array of reflecting facets provides a very thin mirror compared to the spherically convex mirror it simulates. FIG. 12 is an enlarged top sectional view of mirrors 54 and 56 taken along section line 12-12 in FIG. 11. FIG. 12 shows that the facets are progressively more canted relative to the plane surface of mirror 54 in moving from right to left across mirror 56. For clarity, the facets in FIGS. 11 and 12 are shown larger than they really are. While sixty-four facets are shown, a practical mirror will have several hundred facets, and with that many facets the mirror may be as thin as 0.5 mm.

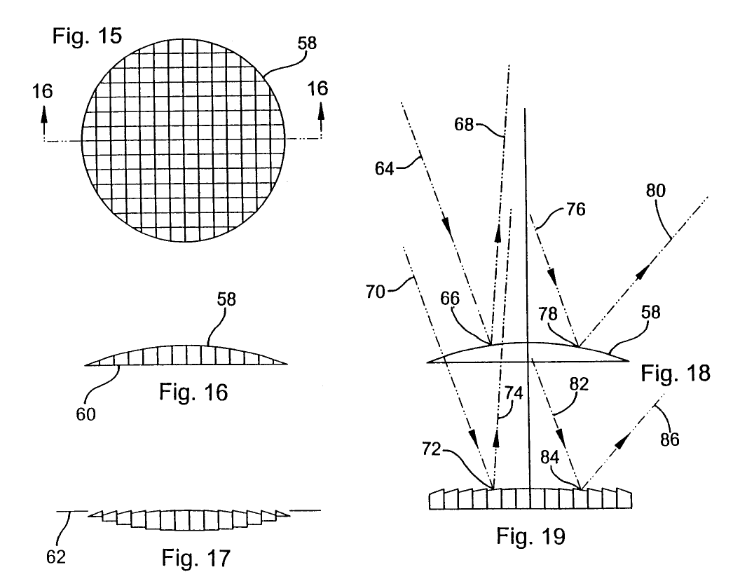

FIGS. 13 to 17 show the concept of creating a planar array of reflecting facets, which will perform the function of a spherically convex mirror. FIG. 13 is plan view of a spherically convex mirror 58 of the familiar bull's-eye type having a radius r. FIG. 14 is a side view of mirror 58 showing how it is a solid segment of a sphere of radius R. The surface of mirror 58 is highly polished and has a reflective coating. In FIG. 15, the mirror of FIG. 13 is cut into an array of squares by an imaginary infinitely thin knife. All of the cuts are perpendicular to the base 60 of mirror 58, as shown in FIG. 16, which is a sectional side view of FIG. 15 taken along section line 16-16. Only one material is present in the cross-section, so crosshatching is not used since this would make the drawing confusing.

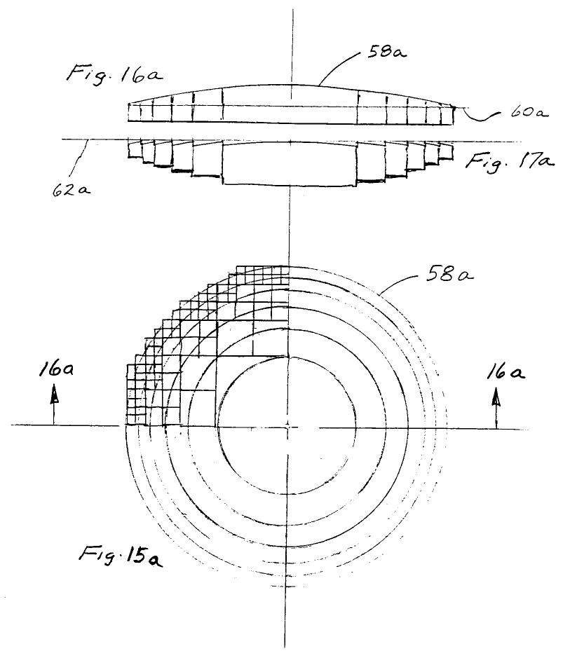

Next, imagine that we take the mirror of FIG. 15, which is now cut up into an array of square rods, turn it upside down, and let the reflecting ends all drop to the same plane surface. Then the rods are adhered together is some manner at the end opposite the polished end so that the reflecting facets stay in the same plane. Now the array may be turned back over to give the planar array of facets of FIG. 17. In this array of facets, the highest point of each facet is located on a reference plane 62. Notice that the slope of each facet in FIG. 17 has the slope of each corresponding segment in FIG. 16. FIGS. 18 and 19 correspond with FIGS. 14 and 17 redrawn to show that the convex mirror and the planar array of facets reflect light in the same way. Parallel light rays reflecting off of corresponding points on the two mirrors reflect in the same direction. For example, ray 64 reflects off of point 66 as ray 68, and ray 70 reflects off of point 72 on the facet as ray 74, which is parallel to ray 68. Likewise, rays 76 and 82 reflect off of points 78 and 84 as parallel rays 80 and 86.

The planar array shown in FIG. 17 is derived from convex mirror 15 that was cut up into squares. However, the facets do not all need to be squares of the same size, or for that matter, even be square. A factor in determining the size of a square is the depth of the facet below line 62 in FIG. 17. This depth determines the practical thickness of an array that can be formed in a thin sheet of plastic. For example, if the maximum depth of a facet at the perimeter of the convex mirror is say 1.0 mm, an injection molding incorporating the facet should be at least 2.0 mm thick. Thus, the planar array shown in FIG. 19 could be 2.0 mm thick with a facet depth of 1.0 mm. Noting in FIG. 17 that the depth of a facet when the squares are all the same size, varies directly with the distance from the center of the mirror, it is obvious that a square starting at the center of the mirror can be much larger before its depth equals that of a square farther away from the center. In fact, it is seen that about three squares in FIG. 19 are required to produce the depth of the outer square if the individual depths of the first three are added up. While the square size depicted in FIG. 15 is not intended to be a practical size, the fact that the squares closer to the center can be larger than the squares farther from the center is verified.

The advantage of using larger squares where possible is that the image quality is better with fewer squares, i.e., the mirror does not have to be divided up into as many pieces to simulate the convex mirror. Also, larger squares have less ability to produce discernable diffraction effects. Finally, the fewer the number of squares required to simulate the convex mirror, the easier it is to build the mold to form the mirror.

The depth of any given facet below line 62 in FIG. 17 is easily determined. Line 60 in FIG. 16 is the chord of arc 58. The distance, d, along the convex mirror axis from the center of the mirror to the chord is:

$$d = R [ 1 - cos ( {sin}^{- 1} \frac{c}{R} ) ] , \qquad Eq . 8$$

where:
R=radius of curvature of the convex mirror (see FIG. 14); and
c=the distance along the chord from the mirror axis to the point where the facet depth is to be determined.
   Or, solving Eq. 8 for c:

$$c = R sin [ {cos}^{- 1} ( 1 - \frac{d}{R} ) ] . \qquad Eq . {8}^{′}$$

Now let's construct a mirror having different sized squares, but formed so that they all have the same depth. Let's select the depth of the facets as 1.0 mm and the radius of curvature of the mirror as 180 mm. We will calculate the distance along the chord, starting at the center of the mirror, and going out from the center in both directions, for successive squares, each having a depth of 1.0 mm. The table below shows the result of this calculation, and FIGS. 16a and 17a, which are like FIGS. 16 and 17, pictorially show the size of the required squares along a diameter.

| d, mm | C, mm | (cₙ-cₙ₋₁), mm |
|---|---|---|
| 1 | 19 | 19 |
| 2 | 27 | 8 |
| 3 | 33 | 6 |
| 4 | 38 | 5 |
| 5 | 42 | 4 |
| 6 | 46 | 4 |

Off of the horizontal or vertical axis, the squares cannot be placed precisely to maintain a depth of 1.0 mm. A slight variation of the depth will not matter. FIG. 15a shows an array of squares comprised of elements that differ from each other in steps of ½ of the previous square's dimension, e.g., the largest square is 20 mm square, the next is 10 mm, then 5 mm and finally 2.5 mm. This dimensioning is desirable to allow the elements to fit together. Again, the depth of the elements will not all be 1.0 mm, but exactness is not required.

The array of FIG. 15a is made by the process described for making the array of FIG. 17. Square metal rods are assembled in a frame, and the ends are machined and polished as group to a convex shape. Then, the frame is slightly loosened and the machined rod ends are all pushed to the same plane, and the frame is tightened. This array can be used in several ways to make a tool to duplicate the array in a transparent material.

FIG. 15a also shows another way to make a planar array, but with circular array elements. First, a solid cylinder is machined for the center element. Then, a group of hollow cylinders are machined to overlap each other with a slight clearance. These cylinders are then pinned at one end and machined and polished on the other end to form a convex surface. The cylinders are then unpinned, the machined end is pushed to the same plane and the cylinders are repinned. Again, this array becomes the basis of a forming tool.

Mirror 58 in FIG. 18 and the planar array of FIG. 19 would correspond exactly if the number of facets could be made infinite. With finite dimensions, there will be some distortion, and the array pattern will be discernible. However, a very good approximation is produced with facets that are in the order of 0.5 mm to 1.5 mm square.

The planar array of facets shown in FIG. 19 simulates the convex bull's-eye mirror of FIG. 14. Any portion of convex bull's-eye mirror 58 may be simulated by a planar array of facets. For example, the convex mirror 36 of FIG. 5, which is actually a portion of a bull's-eye mirror, is easily represented by a planar array.

To show the principal of the planar array of reflecting facets, a convex mirror was imagined being cut up into square elements with an infinitely thin knife. Of course this cannot be done in the real world, but there are practical ways of fabricating such an array. One way is to assemble a group of square steel wires held together by a frame. The wires may be, for example, 3 cm or so long and 0.75 mm square. One end of the assembly is machined to the desired convex shape and then polished to a mirror finish. Next, the pressure on the frame is released just enough to be able to push the machined and polished ends to same plane. The assembly may be re-secured by a variety of methods. Such an assembly can be used in a plastic injection mold to replicate the surface, or it might be used to press the pattern into a plastic or glass surface. The surface of the replica is then coated with a reflective metal by one of several common methods such as sputtering, vacuum deposition or chemical deposition.

The choice of material used for the square wires depends upon the application. For short run injection molding, aluminum wire could be used. For greater durability in an injection mold, hard steel or nickel is required.

The assembly just described was machined to a convex shape. Any replication in another surface formed by the assembly is the negative of the machined surface. That is, looking directly at the pressed or molded surface produced by a convex surface would appear as a concave surface. However, if the pattern is pressed into a thin sheet of transparent plastic or glass and the pattern is viewed through the glass or plastic, it appears as a convex mirror.

Depending upon whether a first surface convex mirror (the reflective coating is on the front or first surface) is desired, or if a second surface convex mirror (the reflective coating is on the back or second surface) is desired, determines if the rod assembly is machined convex or concave. Obviously, a tool used to form a convex mirror on a first surface mirror should be machined concave. Likewise, a tool used to form a mirror appearing convex in a second surface mirror should be machined convex.

While the planar array just described used square facets, other arrays of facets may be used. For example, the facets may be rectangles, parallelepipeds, rings and even irregular random shapes as described by Blom in U.S. Pat. No. 4,674,850. Part of the method used to make a Fresnel lens could be used to make a convex mirror. Fresnel lenses are made by machining very narrow concentric rings in a soft metal with a special diamond tool. The surface of each ring is slightly canted relative to the plane of the lens. As the rings progress outward from the center, the cant angle increases. At the center the cant angle is zero, and at the outer edge of the lens the cant angle may be for example 300. A section through the center of a Fresnel lens will look like the section of FIG. 17. The machined rings are used to press the ring pattern into a transparent plastic. The surface can then be converted to a mirror by applying a reflective coating to it. As with the planar array of square facets, the mirror 36 which is a portion of a bull's-eye mirror, may be simulated by using a portion of a Fresnel bull's-eye pattern. That is, the mirror 36 could be simulated by segments of concentric circular rings.

While the rings of a Fresnel lens are evenly spaced and a fraction of a millimeter apart, the rings do not have to be evenly spaced or close together. A circular array of rings can be made by the process just described for making an array of square facets, but instead of using a bundle of square rods, a bundle of concentric cylinders is used.

Having developed the concept of the planar array of reflecting facets, various ways of using such an array will be shown. While arrays of squares are shown in these examples, it should be understood that any suitable type of array might be used. FIG. 11 has already shown a planar array 56 adhered to mirror 54. The array in this case is molded or pressed into a thin plate of a thermoplastic material. The thermoplastic plate can be quite thin. The thickness depends on the number of facets per square centimeter. Referring to FIG. 19, it is obvious that if more facets are used to simulate the convex mirror of FIG. 16, the depth of the facets will decrease. For example, with facets that are 0.75 mm square, the maximum depth of the edge facets will be in the range of 0.05 mm. Thus, array mirror element 56 in FIG. 12 can have a thickness in the range of 0.5 mm thick and still provide adequate material in which to form the 0.05 mm deep facets.

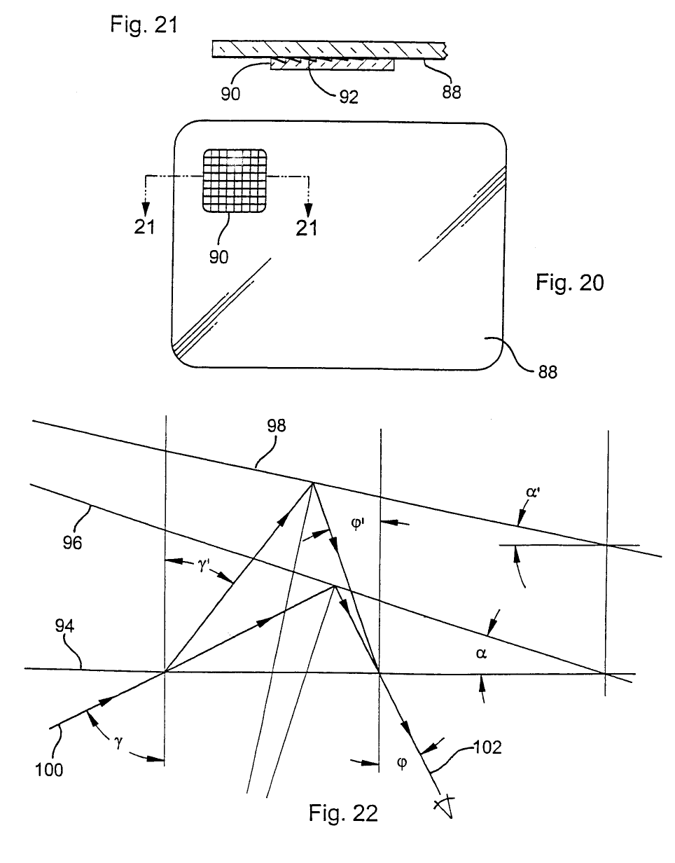

FIG. 20 is a front view of a plane main viewing mirror 88 to which an auxiliary blindzone-viewing mirror 90 has been adhered. Mirror 90 in this embodiment is a thin second surface planar array of reflecting facets as opposed to the first surface planar array of FIG. 11. FIG. 21 is an enlarged top sectional view of mirrors 88 and 90 taken along the section line indicated by 21-21 in FIG. 20. Here, the material of array mirror 90 must be transparent, being glass or plastic. If a plastic is used, it should be one of the optical grades plastics, e.g.: an acrylic such as Lucite manufactured by E.I. du Pont; a polycarbonate such as Lexan manufactured by General Electric; or a cyclic olefin copolymer such as Topas manufactured by the Ticona division of Hoechst. The facets formed in the thin plate of mirror 90 have a reflective metal coating 92 applied to them. Also, if mirror 90 is implemented in a plastic material, its plane first surface may be protected by an optically transparent abrasion resistant coating such as a siloxane. Several companies including G. E. Silicones (Waterford, N.Y.) and Dow Chemical Co (Midland, Mich.) manufacture siloxanes used as transparent hardcoats on plastics. This embodiment has the advantage of protecting the faceted surface and its reflective coating.

Any second surface faceted mirror will produce additional deviation of an incident ray of light due to the fact that the front surface of the glass or plastic and the reflecting second surface of the material are not parallel. In fact, the glass or plastic between the front and back surfaces form a prism. As is well known, a prism produces a deviation of an incident ray which is proportional to the prism angle and the index of refraction of the material of which the prism is composed. Thus, the deviation of a ray caused by a second surface faceted mirror varies from facet to facet, and it is necessary to compensate the mirror for this deviation by changing the prism angles relative to the flat front surface.

If the faceted second surface mirror of FIG. 21 is to have the same field of view as the first surface mirrors of FIGS. 5, 6, 7, 8 and 12, it can be shown that to a first approximation, its element's angles should correspond to those of a convex mirror similar to that of FIG. 5, except that radius 42 in FIGS. 7 and 8 should be greater by a factor of μ, the index of refraction of the glass or plastic, and the angle β between lines 42 and 50 in FIG. 8 should be less by a factor of 1/μ. This results from the fact that the angle of a second surface facet mirror element relative to the plane of the front surface of the thin plate in which the faceted mirror has been formed must be less than the angle of a corresponding element on a first surface faceted mirror due to refraction. FIG. 22 shows why this is so. Here, a line 94 represents the edge a plane parallel to the plane of the unity gain mirror to which the faceted mirror is adhered. Line 96 is a first surface mirror element at an angle α to line 94, and line 98 is a second surface mirror element at an angle α′ to line 94. Line 100 represents a ray of light that reflects off of surface 96, becoming ray 102 going to an observer's eye. Line 100 is at an angle γ to the perpendicular to line 94. Line 102 is at an angle φ to the perpendicular to line 94. Knowing that the sum of the angles in a triangle is 180°, it is seen that for the first surface mirror,

$$α = \frac{γ - ϕ}{2} \qquad Eq . 9$$

For the second surface mirror, the region between lines 94 and 98 is a refracting medium having an index of refraction μ. Ray 100 is refracted at line 94 such that the angle of refraction, γ′, is related to incident angle γ by the familiar equation,

$$\frac{sin γ}{sin {γ}^{′}} = μ \qquad Eq . 10$$

### Solving for γ′,

$${γ}^{′} = {sin}^{- 1} ( \frac{sin γ}{μ} ) . \qquad Eq . 11$$

The refracted ray reflects off of surface 98, and at line 94 again undergoes refraction, emerging along line 102. In leaving the refractive medium at line 94, the ray bends away from the perpendicular to line 94, so that,

$${ϕ}^{′} = {sin}^{- 1} ( \frac{sin ϕ}{μ} ) \qquad Eq . 12$$

Again using the geometry of triangles, it can be shown that

$${α}^{′} = \frac{{γ}^{′} - {ϕ}^{′}}{2} . \qquad Eq . 13$$

Substituting Eq. 11 and 12 into Eq. 13,

$${α}^{′} = \frac{1}{2} [ {sin}^{- 1} ( \frac{sin γ}{μ} ) - {sin}^{- 1} ( \frac{sin ϕ}{μ} ) ] . \qquad Eq . 14$$

Using the power series expansion for the arcsine and sine, and assuming γ and φ are small,

$${α}^{′} ≅ \frac{1}{2} ( \frac{γ}{μ} - \frac{ϕ}{μ} ) ≅ \frac{1}{μ} ( \frac{γ - ϕ}{2} ) ≅ \frac{α}{μ} . \qquad Eq . 15$$

Hence, to a first approximation, the angle of a given facet on a second surface mirror is reduced by a factor of 1/μ compared to a corresponding facet on a first surface mirror.

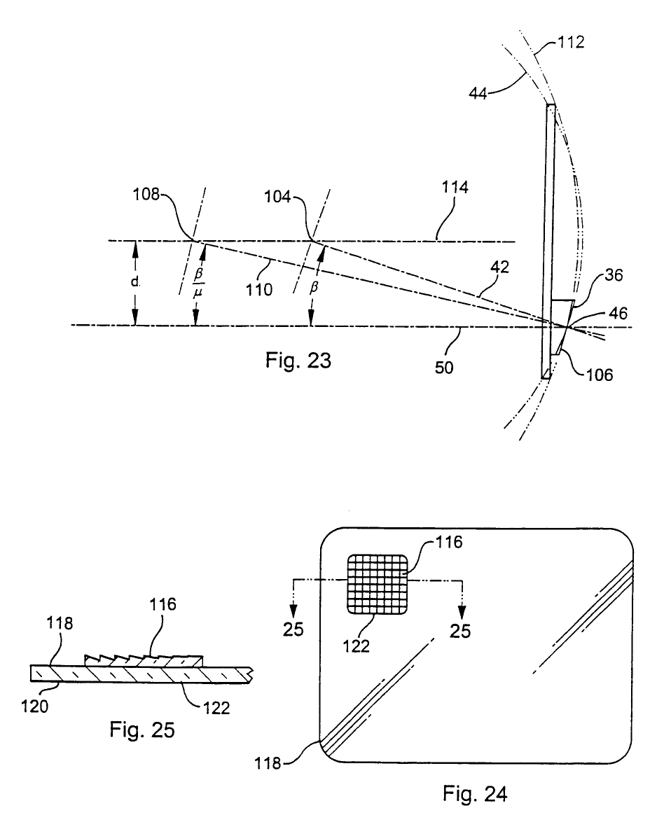

Since the angle of each facet on a second surface mirror is reduced by a factor of 1/μ, this obviously increases the spherical radius of the second surface mirror as compared to the first surface mirror. In fact, we can guess that the radius is increased by a factor of μ, but to verify this, let's return to FIG. 8 and examine the top view of mirror 36 repeated in FIG. 23. Arc 44 includes the surface of the front surface spherical mirror 36 in FIG. 8. That sphere is centered at point 104 and it has a radius indicated by line 42. Line 42 is at an angle β to line 50, which is perpendicular to mirror 40. If a second surface mirror is to produce the same view as mirror 36, β must be reduced by a factor of 1/μ since radii 42 and 110 are respectively perpendicular to arcs 44 and 112 at point 46, and the lines tangent to arcs 44 and 112 at point 46 are related by Eq. 15. Hence, the radius 110 of the sphere generating the second surface mirror must be at an angle β/μ to line 50, and its center 108 must lie on line 114 for arc 112 to pass through point 46 in the direction of line 110. Second surface 106 must be interpreted in view of second surface 134 in FIG. 31. In FIG. 23, a refracting medium is not shown in front of surface 106 since the drawing would then become confusing. Since spherical arcs 44 and 112 both pass through point 46, and both spheres are symmetrical about axis 114, then

$$d = R sin β = R sin \frac{β}{μ} , \qquad Eq . 18$$

where:
d=the distance between line 50 and line 114;
R=radius 42 of first surface mirror 36; and
R′=radius 110 of second surface mirror 106.

### Solving for R′,

$${R}^{′} = R \frac{sin β}{sin \frac{β}{μ}} . \qquad Eq . 19$$

Again using the power series approximation,

R′≅μR. Eq. 20

Equation 15 and Equation 20 are approximations. Accurate values of α′ and R′ are obtained using a computer solution.

FIGS. 24 and 25 show another embodiment of this invention wherein a faceted mirror 116 is adhered to the back of a first surface plane mirror 118. FIG. 24 is a front view of mirror 118. FIG. 25 is an enlarged top sectional view of mirrors 116 and 118 taken along section line 25-25 in FIG. 24. Since mirror 118 is a first surface mirror having a reflective coating 120 on the front surface, the metallization in front of mirror 116 must be removed for mirror 116 to be visible from the front. Thus, a window 122 in the metallization is provided for this purpose. The faceted mirror 116 is a second surface mirror, and it is adhered to mirror 118 with a clear adhesive, preferably having an index of refraction near that of the glass to avoid reflections at the adhesive interface. An example of such an adhesive is an ultraviolet cured acrylic adhesive manufactured by the Loctite Corporation of Rocky Hill, Conn. This particular product is designated as their 3494 adhesive, and it has an index of refraction of 1.48. The embodiment shown in FIGS. 24 and 25 provides protection for the faceted mirror and keeps the plane mirror a first surface mirror, which is the common type of mirror in use. The arrangement shown in FIGS. 24 and 25 could also be implemented with mirror 118 being a second surface mirror.

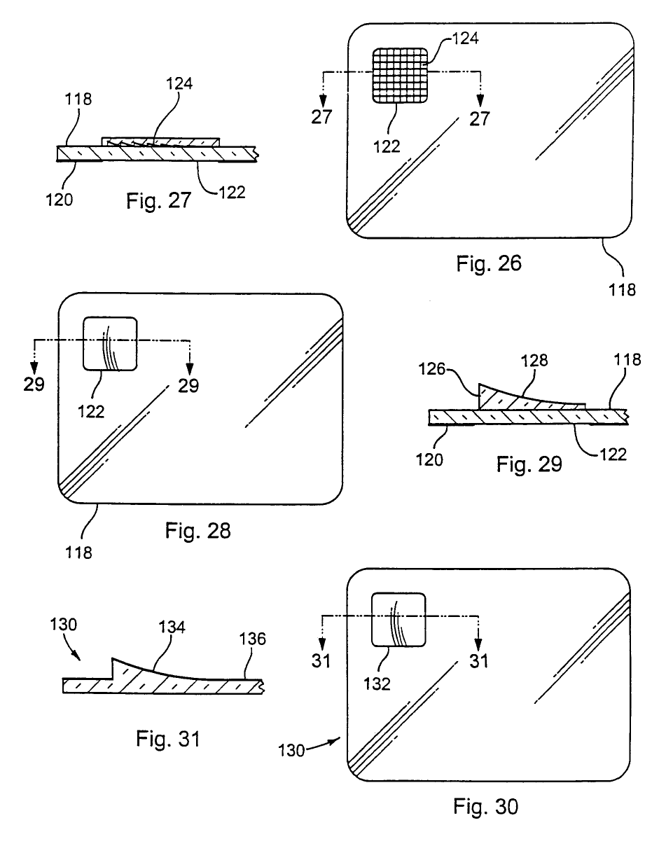

FIGS. 26 and 27 are like FIGS. 24 and 25, and like elements are identified with like reference numbers. The difference lies in the fact that the adhered faceted mirror 124 has the facets formed on the inner face. Here, care must be taken to assure that the clear adhesive is applied so that no air is trapped between the main mirror 118 and auxiliary blindzone-viewing mirror 124 since air bubbles would interfere with the reflections seen. This arrangement provides additional protection for the facets. It should be noted that with this arrangement of using a clear adhesive uniformly applied between the facets and the back surface of mirror 118, mirror 124 becomes a second surface mirror. Additional care must be taken when designing this mirror since the glass and the adhesive may have different indices of refraction. Mirror 124 could also be adhered only along its perimeter, in which case it is optically a first surface mirror in the sense that the angle of a reflected ray is not influenced by the refraction that occurs as the ray passes through 118.

FIGS. 28 and 29 are also like FIGS. 24 and 25, and again like elements are denoted by like reference numbers. The difference here is that the faceted blindzone-viewing mirror has been replaced by solid clear plastic element 126 having a spherically concave rear face with a reflective coating 128. It is also adhered to the main viewing mirror 118 with a transparent adhesive, again having an index of refraction near that of the glass and the plastic to minimize reflections at the plane of the adhesive. Mirror surface 128 is viewed through window 122 where it is seen as a spherically convex mirror. The advantage of this embodiment is that use of the planar array can be avoided in those applications where there is adequate space behind the main viewing mirror 118 to accommodate the volume of element 126 without interfering with the mirror positioning mechanism.

FIGS. 30 and 31 show a rearview mirror 130 formed in a transparent material wherein a concave portion is molded integrally with a plane portion. The entire back surface of mirror 130 is coated with reflective material so that mirror 130 is a second surface mirror. FIG. 30 is a front view of mirror 130. Area 132 is the region in which concave portion 134 is visible. FIG. 31 is an enlarged top sectional view of mirror 130 taken along section line 31-31 in FIG. 30. In FIG. 30, concave surface 134 appears as a segment of a spherical convex mirror lying in region 132 when viewed from the front. Second surface 136 appears as a plane mirror when mirror 130 is viewed from the front. The advantage of this embodiment is that the use of adhesives is avoided, and it is a single component.

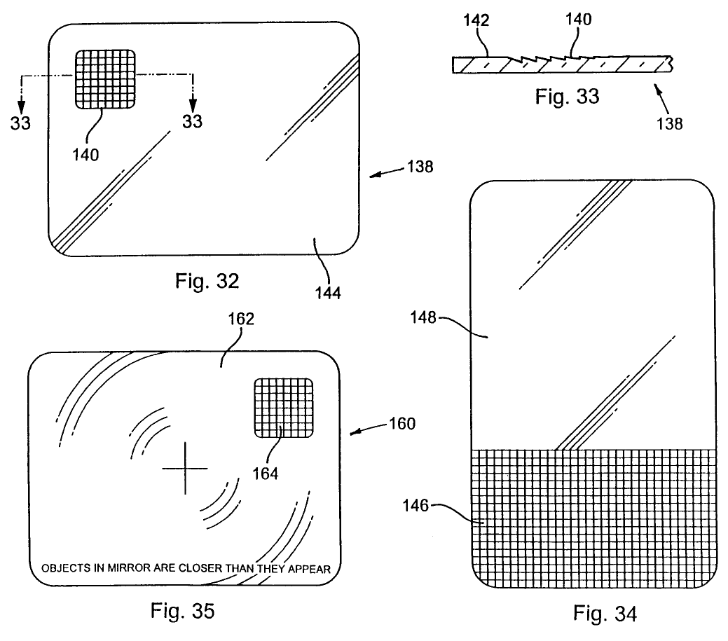

FIGS. 32 and 33 depict a mirror 138 having a faceted blindzone-viewing portion 140 formed integrally with a plane main viewing portion. The entire back surface of mirror 138 has a reflective coating 142, making it a second surface mirror. FIG. 32 is a front view of mirror 138, showing faceted portion 140 and plane portion 144. FIG. 33 is an enlarged top sectional view of mirror 138 taken along the section line indicated by 33-33. Faceted portion 140 is formed in the material of which mirror 138 is made. Mirror 138 may be plastic or glass. It may be a molding, or the facets may be pressed into sheet stock. If the material of 138 is a plastic, the front surface may be protected with a hardcoat as previously described. The advantage of this embodiment is that it requires no additional space, and the current mirror glass can be directly replaced with mirror 138.

Preferably, the faceted portion 140 in FIG. 32 should have as high a reflectivity as possible, being coated with aluminum or silver. Since the blindzone-viewing portion is a second surface mirror, the first surface will have a reflection of about 4%, which will be faintly visible over the reflection from the blindzone-viewing portion. The two reflections are in different directions, and are of different magnifications. By keeping the reflection from the less than unit magnification mirror as high as possible, the reflection from the first surface is less noticeable. This applies to any of the embodiments utilizing a second surface blindzone-viewing mirror.

FIG. 34 shows a truck type of mirror incorporating some of the principles described above. Most truck mirrors are taller than they are wide as indicated in FIG. 34. Many of these mirrors use a large bull's-eye convex mirror attached at the lower end to increase the horizontal field of view so that the blindzone may be seen. FIG. 34 shows a convex faceted mirror 146 on the lower end of a main unit magnification mirror 148. Mirror 146 has been optimized to view primarily the blindzone. Any of the methods described above may be used to form the mirror of FIG. 34.

The passenger's side outside mirror is also subject to restrictions imposed by FMVSS 111. Because that mirror is so far away from the driver, the field of view of a unit magnification mirror of the same size as the mirror on the driver's side would be only about 10°. This would result in a very large blindzone on the passenger's side. For this reason, FMVSS 111 allows a convex mirror having a wider field of view to be used. This of course reduces the size of the images seen in the mirror. FMVSS 111 says that the radius of curvature used on passenger's side mirrors “shall be not less than 34 inches and not more than 65 inches.” It also requires that the mirror be inscribed with the statement, “Objects in Mirror are Closer Than They Appear.” At a radius of curvature of 1651 mm (65 inches), the magnification is about 0.30, and the field of view is about 27°. A radius of curvature of 1016 mm (40 inches) is in common use. Using the largest possible radius of curvature increases the image size, but it also increases the size of the blindzone.

Returning to FIG. 1, lines 150 and 152 define the viewing angle of a 1651 mm radius convex mirror 154. When the driver is looking at mirror 154, the peripheral vision line is approximately shown by line 156. However, because passengers and the vehicle structure block the driver's peripheral vision to the road, the peripheral vision line cannot be used to define the blindzone as on the driver's side. A line 158 extending from the driver's eyes through the right rear door window is about the limit of the driver's vision to the rear. A blindzone then exists between lines 152 and 158, and it is shown crosshatched. This blindzone may be removed by providing an auxiliary blindzone-viewing mirror as in FIG. 5, except that such an auxiliary mirror must be placed in the upper right hand corner, as shown in FIG. 35.

In FIG. 35, a passenger's side mirror 160 has a surface 162 that is a spherically convex mirror having a radius of curvature falling within the requirements of FMVSS 111, and mirror 164 is a less than unit magnification mirror designed to view generally only the blindzone. Mirror 164 should have a field of view encompassing the region between lines 152 and 158, and that will require a field of view in the range of 25 to 30 degrees. If the width for mirror 164 is to be 4.5 cm with a viewing angle of 30 degrees and S_{T}=140 cm, its required radius of curvature calculated from Eq. 7 is 20 cm.

While being able to use the largest possible radius of curvature for mirror 164 is an advantage, the main advantage of having a right side blindzone-viewing mirror is that such a mirror unambiguously tells you that you cannot change lanes if a vehicle is visible in that mirror. Without the blindzone viewing mirror, it is necessary to try to judge the position of a vehicle seen in a mirror which has an image size ⅓ of that in direct vision. Mirror 160 can be implemented by any of the arrangements used on the driver's side mirror. And obviously, main viewing mirror 162 which is also a less than unit magnification mirror, may be implemented as a planar array of reflecting facets, with or without the blindzone-viewing mirror.

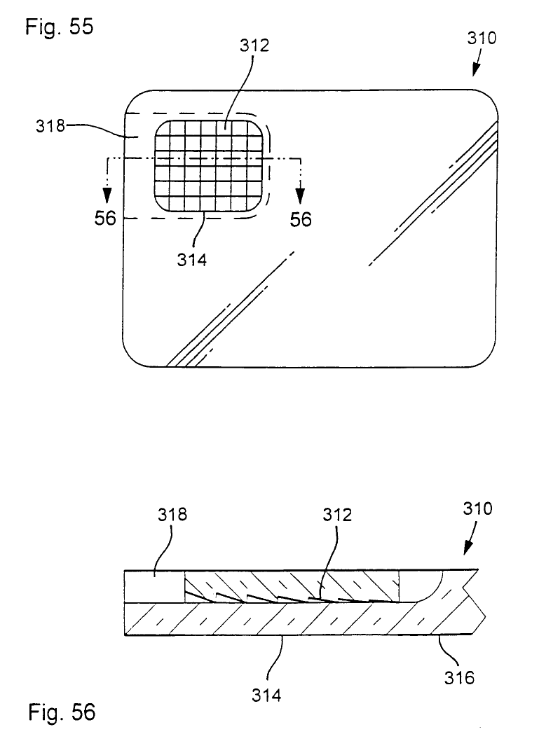

FIGS. 55 and 56 show an arrangement similar to that shown in FIGS. 26 and 27, both of which show a discrete first surface planar array of reflecting facets adhered to the second surface of a first surface plane mirror having a window in the first surface reflective coating through which the planar array is viewed. FIG. 55 is a front view of a first surface plane mirror 310 having a faceted mirror 312 adhered to its back surface. The faceted mirror 312 is viewed through a window 314 in the first surface reflective coating 316 on mirror 310. FIG. 56 is an enlarged partial sectional view of the mirror of FIG. 55 taken along section line 56-56 in the direction of the arrows. Here it is seen that a recess 318 is ground in the back surface of mirror 310, and faceted mirror 312 is adhered in the recess. Again, an adhesive having an index of refraction near that of the glass and the plastic of the discrete mirror is used to prevent reflections at the interface of the glass and the faceted mirror. Having the index of refraction near that of the glass also allows the recess to be rough ground and not polished, since the adhesive will fill all of the surface asperity making the grind marks invisible. The ground recess is shown starting at the left edge and proceeding only far enough to accept the size of the planar array. If the array fills the whole upper corner, the recess is obviously ground accordingly. The advantage of providing the recess is that it allows the faceted discrete mirror to be flush with the back surface of the mirror. Remembering that the discrete mirror can be as thin as 0.5 mm, removing this much from the back of a 2 mm thick glass is quite feasible. Hence, the mirror of FIGS. 55 and 56 can directly replace a standard mirror without requiring any modification to the outside mirror assembly. While a thin first surface faceted mirror is shown in FIGS. 55 and 56, obviously, a thin second surface faceted mirror may also be used.

So far, all of the mirrors shown have had a constant reflectivity. It is also possible to use the blindzone viewing technology herein disclosed in conjunction with the technology used to provide variable reflectivity mirrors. Various unique combinations of the two technologies combine to provide a new and novel category of mirrors.

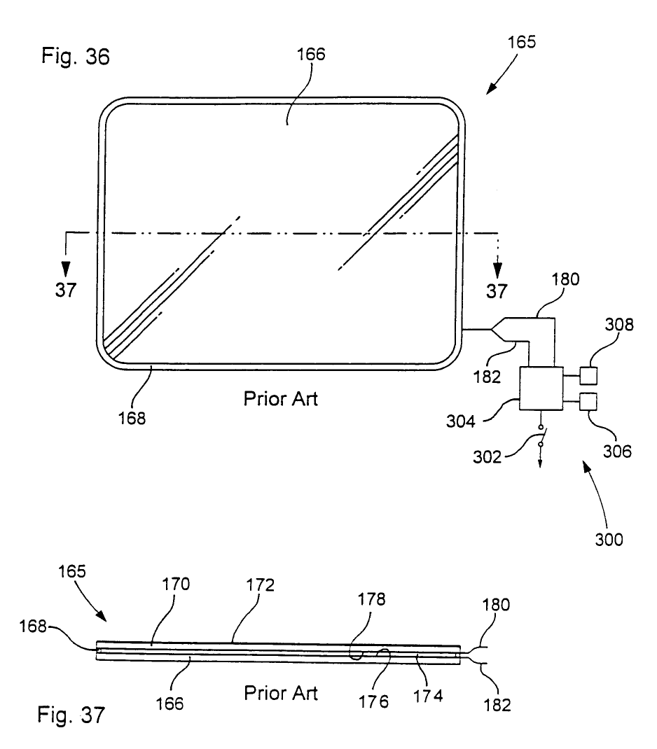

FIGS. 36 and 37 show the generic structure of prior art variable reflectivity mirrors. In general, such mirrors are comprised of a transparent front plate, a rear plate which may or may not be transparent, and a chamber between the two plates which is sealed at their perimeter. Not shown is the manner in which the two plates are held together and their spacing maintained. The chamber is filled with a material that is able to effect a change in the intensity of the reflection from such a mirror. The material may be liquid, gel or solid. FIG. 36 is a front view of such a prior art mirror 165 showing a front plate 166 and a perimeter seal 168. FIG. 37 is the section indicated by section line 37-37 in FIG. 36 in the direction of the arrows. In addition to front plate 166, a rear plate 170 is shown that has a reflective coating 172 applied to its second surface. Perimeter seal 168 is also seen. A chamber 174 exists between the plates. Several materials can be used to fill chamber 174. At present the most extensively used filling is a so-called electrochromic material. This material changes its ionization state when an electric current is passed through it, and in this state it changes its color to a deep bluish green. The material in this state absorbs visible light photons. They are absorbed as light passes through the front plate and into the electrochromic layer and again as the light passes through the rear plate, reflects at coating 172 and exits through the electrochromic material and the front plate 166. The density of the ionized material, and hence the intensity of the light reflected from reflective coating 172, is controlled by the current. Electrically conductive transparent coatings 176 and 178 are applied to the second surface of the front plate 166 and to the first surface of the rear plate 170, respectively. Coatings 176 and 178 are required to obtain uniform current flow through the electrochromic material. A commonly used material for transparent electrically conductive coatings is indium tin oxide, known as ITO. Also indicated in FIGS. 36 and 37 are wires 180 and 182 connected to the ITO by methodologies not shown, but which are well known in the art.

In FIG. 36, mirror 165 is connected electrically in-circuit with a reflectivity control circuit 300 typically comprised of a series interconnected activation switch 302, an electronic control circuit 304, a rear facing light sensor 306 and an ambient light sensor 308. Control circuit 300 is in circuit with mirror 165 via wires 180 and 182 to establish an electric current therein and thus selectively vary the ionization state of the electrochromic material. As the illumination from the rear and the ambient illumination vary, electronic control circuit 304 produces a variation in the current to the electrochromic material thereby altering the reflectivity of the mirror in such a way as to keep the illumination reaching the driver's eyes below the annoyance level. A discussion of the relationship between illumination from the rear and ambient illumination in automatic control of rearview mirrors is found in U.S. Pat. No. 3,601,614 Aug. 24, 1971; G. E. Platzer, Jr.

In addition to electrochromics, liquid crystals have been used. Liquid crystals change their ability to polarize light under the influence of an electric field, and when used with a polarizer, the intensity of light passing through such a cell can be controlled by the electric field strength. The liquid crystal mirror controller suffers from a low maximum reflectivity due to an immediate 50% loss due to a polarizer. Furthermore, a loss of power puts it in the minimum reflectivity state.

Another method for controlling reflectivity uses an electroplating process. Here, the chamber is filled with an electrolyte containing ions such as silver which when plated out on either inside surface of the cell produces a reflective surface. The reflectivity is controlled by controlling the amount of silver plated out of the electrolyte. The process is reversible, so the reflectivity can be reduced by removing silver from the surface of the plate chosen to be the mirror.

In the future, additional materials that change their optical transmission in response to an applied electric field or current will probably be discovered, and the teachings of this invention apply to any variable reflectivity mirror.

As with the generic variable reflectivity mirror just described, none of the following mirror configurations will show the manner in which the front and rear plates are held together or how the spacing is maintained. The intent is to delineate the types of mirrors that can be used in a variable reflectivity mirror having a main viewing mirror and an auxiliary blindzone viewing mirror and the unique relationship of the reflective surfaces used in such mirrors.

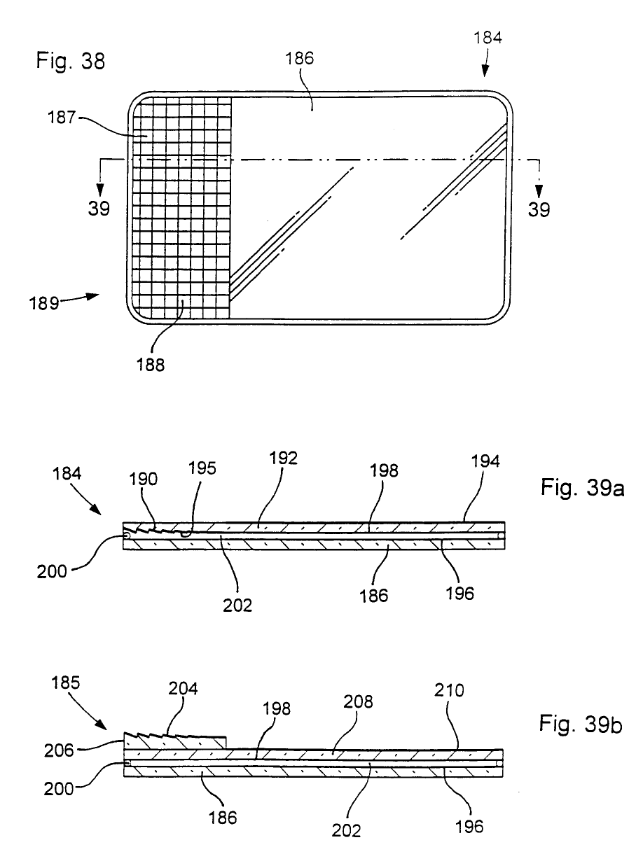

FIGS. 38, 39a and 39b show two different configurations, but in a front view they both look the same. Like elements have been given like identification numbers. FIG. 38 is a front view of a variable reflectivity mirror 184 that has a plane mirror region 186 and an auxiliary blindzone viewing mirror 187 at the outer end (generally indicated at 189) formed by a planar array of reflecting facets 188 simulating a convex mirror. The advantage of this configuration is that many European and Asian drivers have become accustomed to a mirror with an aspheric mirror at the outer end of the mirror 184, and an aspheric mirror is easily simulated by the planar array.

FIG. 39a is a sectional view of FIG. 38 taken along line 39-39 in the direction indicated by the arrows showing one way of implementing mirror 184. Here, a planar array of reflecting facets 190 is integral with and on the first surface of rear plate 192. Reflective coatings 194 and 195 are applied to the second surface of the rear plate 192 and to the surface of planar array 190 respectively. Transparent electrically conductive coatings 196 and 198 are applied to the second surface of front plate 186 and to the first surface of rear plate 192, respectively. A seal 200 between the front and rear plates 186 and 192 provide a chamber 202 which is filled with one of the electrically active materials capable of changing the intensity of the light reflected from mirror surface 194. Note that in FIG. 39a the transparent electrically conductive coatings 196 and 198 do not extend in front of planar array 190. While the region between the plates 186 and 192 in front of auxiliary mirror 187 is filled with an electrically active material, a current cannot flow nor can a field exist in that region, and for that reason the reflection from mirror 187 remains unaffected. This is desirable since a convex mirror already has a reduced reflectivity in comparison to a plane mirror, and as shown in SAE Paper 950601, the relative illuminance of a convex mirror is equal to the square of the relative magnification. For example, if the relative magnification of a convex mirror is 0.2, the relative illuminance is 0.04. Dimming such a low magnification mirror is undesirable. If mirror 184 is very large, it is possible that the radius of curvature simulated by planar array 188 may be large enough to produce a relative illuminance which would make it desirable to dim the light reflected from planar array 188. In this case the ITO layers would be extended to the area in front of array 190.

FIG. 39b shows mirror 185 which is a variation of the mirror of FIG. 39a wherein the planar array of reflecting facets 204 is a second surface mirror on a discrete element 206 whose first surface is adhered to the second surface of a rear plate 208. A reflective coating 210 has been applied to the second surface of rear plate 208 which is similar to coating 194 in FIG. 39a. Again, the reflectivity from planar array 204 may be controlled or uncontrolled depending upon the placement of the ITO coating.

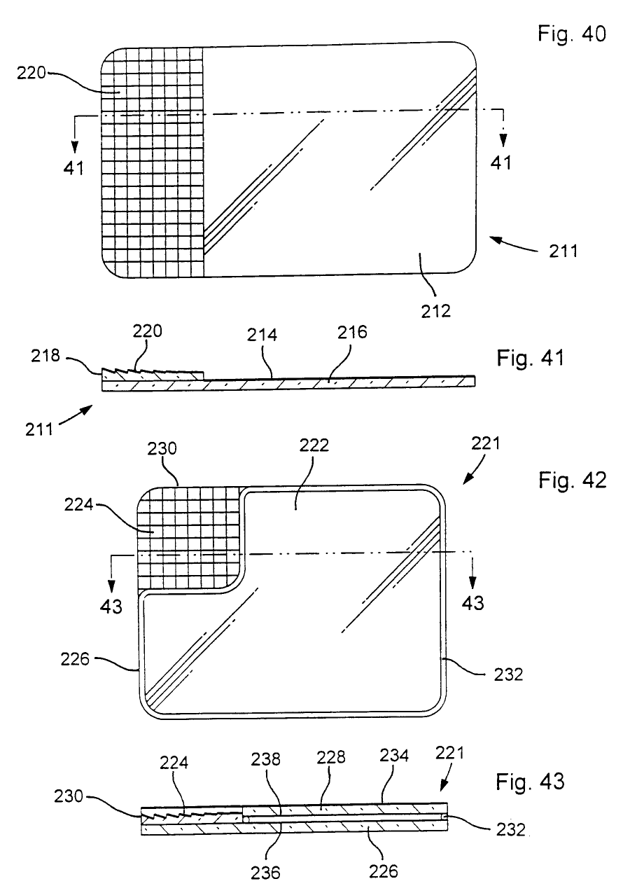

A non-dimming mirror in the configuration of FIG. 38 is shown generally at 211 in FIGS. 40 and 41. As in FIG. 38, the planar array of reflecting facets 220 is shown at the outer end of this mirror. A plane main viewing mirror 212 is provided by means of second surface reflective coating 214 applied to plane plate 216. An auxiliary blindzone viewing mirror is provided by a discrete element 218 carrying a second surface planar array of reflecting facets 220. The first surface of element 218 is adhered to the second surface of plate 216. Planar array 220 may simulate either a spherical or aspherical convex mirror. The advantage of this non-dimming configuration is that it may be desirable to retain some features of the European and Asian mirrors as described in the discussion of FIG. 38. The vast majority of European and Asian mirrors are non-dimming, so it is desirable to be able to provide the mirror of FIGS. 40 and 41. While a discrete adhered mirror is shown in FIG. 41, any of the previously described methods of providing a planar array may be used.

For the US market, use of the blindzone mirror in the upper and outer quadrant of a mirror is preferred for reasons previously described. Therefore, various ways of modifying the variable reflectivity mirror to accept an auxiliary blindzone viewing mirror in this configuration will be shown. FIG. 42 shows a variable reflectivity mirror 221 with a plane main viewing portion 222 and a blindzone viewing portion 224 comprised of a planar array of reflecting facets. FIG. 43 is a sectional view of the mirror of FIG. 42 taken along section line 43-43 and in the direction of the arrows. A front plate 226 covers the entire area defined by the perimeter of the mirror shown in FIG. 42. A rear plate 228 is notched out to accept blindzone viewing mirror 224 which is a second surface planar array mirror formed in transparent discrete element 230. The first surface of mirror element 230 is planar, and it is adhered to the second surface of front plate 226. A seal 232 must now cover the perimeter of plate 228, so it will be seen as shown in FIG. 42 with a jog around mirror element 230. A reflective coating 234 is applied to the second surface of rear plate 228, and ITO coatings 236 and 238 are applied to the inside surfaces of plates 226 and 228, respectively. Since mirror element 230 is adhered to the second surface of front plate 236, there is no electrically active material in front of the planar array, so the reflection from the planar array does not dim. Conductive leads (not shown), such as in FIGS. 36 and 37 could be used to place mirror 221 in circuit with a power supply and control circuit.

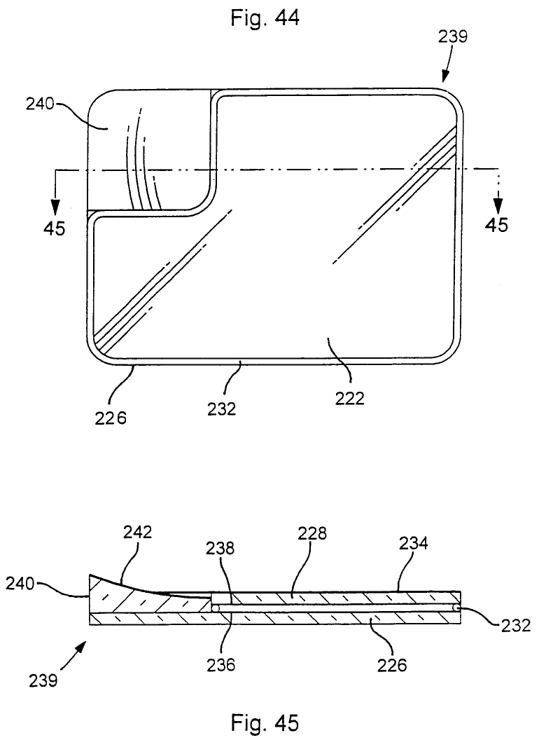

FIGS. 44 and 45 show a modification of the mirror of FIGS. 42 and 43 wherein a variable reflectivity mirror 239 has the planar array mirror element 230 replaced with a solid clear element 240 having a spherically concave rear surface with a reflective coating 242. Like elements in these Figures are identified with like numbers. From the front, element 240 appears as a spherically convex mirror, and as such it performs the function of providing a wide angle view of the blindzone, as does the planar array of FIGS. 42 and 43.

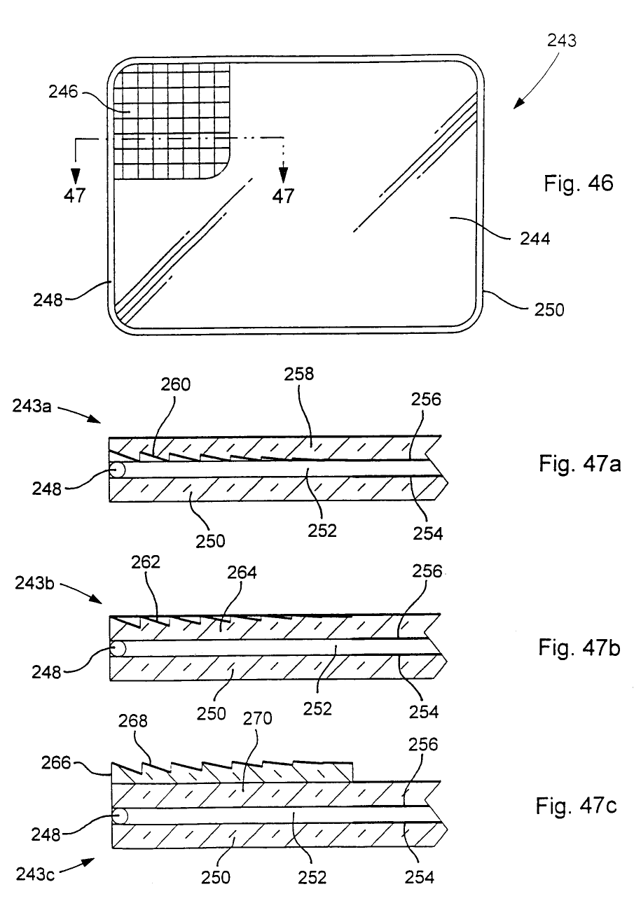

FIGS. 47a, 47b and 47c show three alternative configurations 243a, 243b and 243c of a mirror depicted generically in FIG. 46 and identified as 243. All of the alternative configurations 243a, 243b and 243c use a planar array and appear the same from the front. In FIG. 46, region 244 has a magnification of unity, providing a reflection from a plane mirror. Region 246 has a magnification of less than unity, providing a reflection from a planar array of facets simulating a convex mirror. Also seen in FIG. 46 is seal 248 that seals in the electrically active material which dims the reflection from the mirror. In FIGS. 46 through 47c, like elements will be identified by like numbers. FIGS. 47a, 47b and 47c are enlarged sectional views taken along section line 47-47 in the direction indicated by the arrows. All three drawings show a front plate 250, a seal 248, a chamber 252 retaining the electrically active dimming material and ITO coatings 254 and 256 on the inside surfaces of the chamber. FIG. 47a has a rear plate 258 with an integrally formed planar array 260 having a reflective coating. Planar array 260 may be made dimming or non-dimming depending upon whether or not the ITO coating is used in the region in front of array 260.

Variable reflectivity in both region 244 and 246 of mirror 243 can be accomplished by providing a second seal (not illustrated) around the periphery of region 246 to define two separate chambers (such as chamber 252), each filled with electrochromic material. In addition, separate electrically isolated ITO coatings would be provided in the front and rear plate surfaces within the chamber co-extensively with region 246. Lastly, a separate set of wires would interconnect the additional ITO coatings with a second reflectivity control circuit. Thus arranged, the primary mirror and the auxiliary blindzone viewing mirror could each have a characteristic reflectivity independent of one another.

FIG. 47b has a planar array mirror 262 formed in the second surface of rear plate 264. Again, the array may be dimming or non-dimming.

FIG. 47c uses a separate element 266 having a planar array mirror 268 formed in its second surface. Its first surface is adhered to the second surface of rear plate 270. This configuration has the advantage of allowing the use of a standard variable reflectivity mirror. However, if dimming of the blindzone mirror is not desired, the ITO coating must not extend in front of mirror 268. Planar arrays 260, 262 and 268 are coated with a reflective surface as described earlier in conjunction with aforementioned embodiments of the invention.

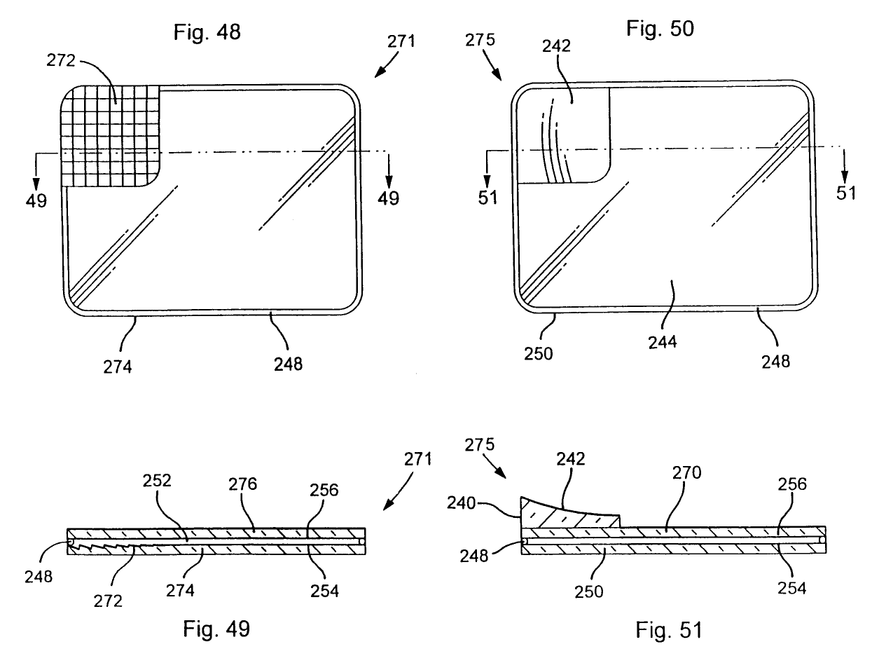

The mirror 271 of FIGS. 48 and 49 is very similar to the mirror of FIGS. 46 and 47a. Again, like numbers will be used to identify like elements. The only difference between these mirrors is that the planar array of reflecting facets 272 is integrally formed in the second surface of front plate 274 rather than in the first surface of the rear plate 276. In this configuration, the planar array is non-dimming since the array is in front of the electrically conductive material. Also, since the array is in front of the chamber, the seal 248 does not show behind the array 272 which has its second surface coated with a reflective material. Alternatively, rear plate 276 can be provided by a thin reflective layer deposited directly upon the rear surface of the electrochromic layer.

FIGS. 50 and 51 show a mirror 275 similar to FIGS. 46 and 47c, and again like numbers will be used to identify like elements. The difference is that element 266 carrying planar array 268 has been replaced with the concave mirror element 240 of FIG. 45 which is now adhered to the second surface of rear plate 270. This configuration is an alternate method to using the planar array of FIG. 47c.

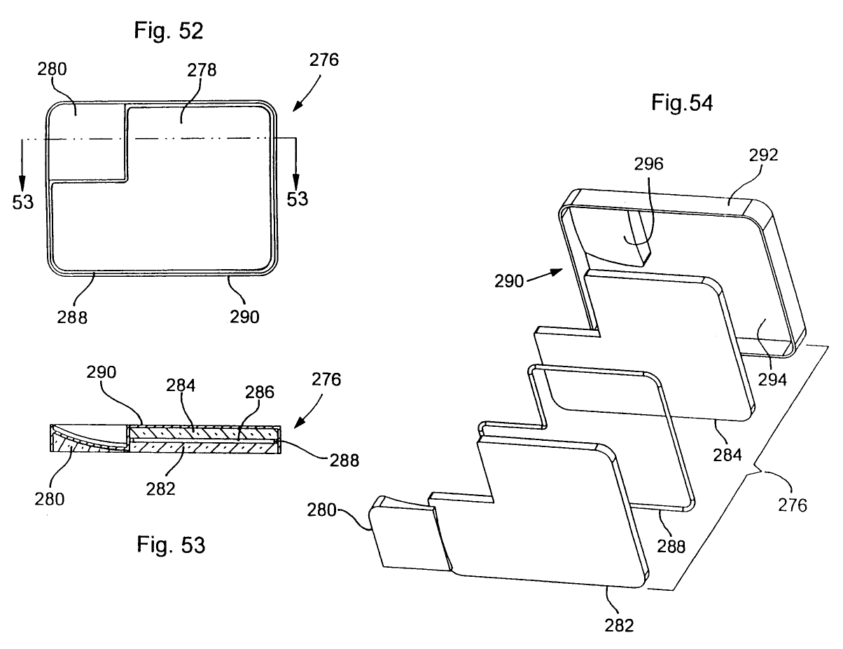

FIGS. 52, 53 and 54 show yet another alternative to producing a blindzone viewing mirror 276 with a flat front face, and in this case it is incorporated with a variable reflectivity mirror. FIG. 52 is a front view of the mirror. It has a unity magnification region 278 and a less than unity magnification mirror 280 for viewing primarily only the blindzone. FIG. 53 is a sectional view of the mirror 276 of FIG. 52 taken along section line 53-53 in the direction of the arrows. A customarily constructed variable reflectivity mirror is indicated by front plate 282, rear plate 284, chamber 286 containing an electrically active material and a chamber seal 288. The upper and outer corner of the variable reflectivity mirror is notched out to provide space for the blindzone viewing mirror 280. Like mirror 240 of FIGS. 45 and 51, mirror 280 is a segment of a second surface concave mirror. A plastic or metal case 290 supports the variable reflectivity mirror and the concave mirror in such a manner that the first surface of mirror 280 is coplanar with the first surface of front plate 282. FIG. 54 is an exploded view of FIG. 53 showing the construction of case 290 and how the components fit into it. Case 290 has a sidewall 292 extending around its perimeter, a back wall 294 and a shelf 296 which matches the concave surface of mirror 280. The height of shelf 296 is such that when the variable reflectivity mirror and mirror 280 are in place in the case, the first surfaces of the mirrors are coplanar. These first surfaces may be contiguous or they may be separated by a thin additional wall that may be molded into case 290. Thus, a variable reflectivity mirror and a blindzone viewing mirror are combined to produce a mirror with a flat front face. This same type of structure may be used to combine an ordinary plane non-dimming mirror and a second surface plano-concave blindzone viewing mirror to also have a flat front face.

If any of the mirrors shown which utilize a second surface blindzone viewing mirror are to be used in conjunction with a passenger's side mirror, the first surface of the blindzone viewing mirror must be changed to a spherical surface to match the curvature of the main viewing mirror.

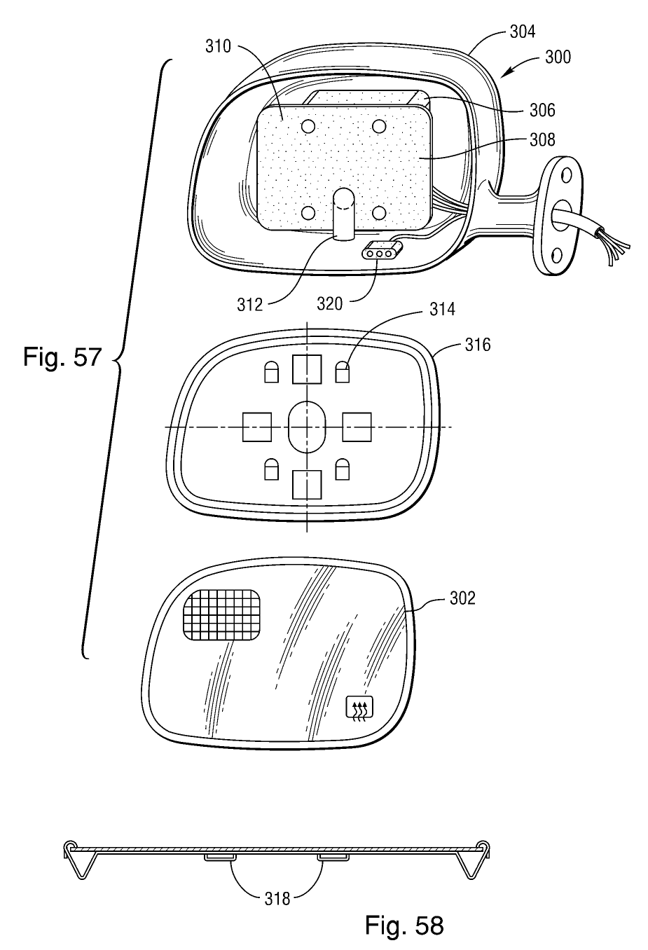

A mirror assembly 300 utilizing a two zone mirror element 302 of the type previously described is shown in FIG. 57. Mirror assembly 300 is made up of a mirror housing 304, a mirror position motor 306 which can be remotely actuated by the vehicle occupant using an electrical switch within the vehicle to position face plate 308. Face plate 308 is provided with a series of posts 310 and a lock on lock lever 312. Posts 310 are adapted to cooperate with a series of apertures 314 and mirror bezel 316. Mirror bezel 316 is a plastic molding adapted to securely retain two zone mirror 302, as illustrated in the FIG. 58 cross-section. Bezel 316 is provided with a series of clips 318 adjacent apertures 314 and bezel 316 for engaging posts 310 on face plate 308. With clips 318 cooperating with posts 310, the lock/unlock lever is moved to the lock or unlock position as desired to retain or release the bezel relative to the face plate. In instances when mirror 302 is of the electrochromic or heated variety, an electrical connector not shown in the mirror will be coupled to electrical connector 320 within housing 304.

Referring back to FIGS. 30 and 31, a rearview mirror 130 having a plane portion is integrally molded with a concave portion. The entire front surface of mirror 130 is planar and the entire back surface of mirror 130 is coated with the reflective material, including the concave portion, thus creating a second surface mirror. While the concept of an integral mirror is advantageous, this particular embodiment has its limitations. The rearview mirror 130 must be a second surface mirror and hence, must be formed of transparent material.

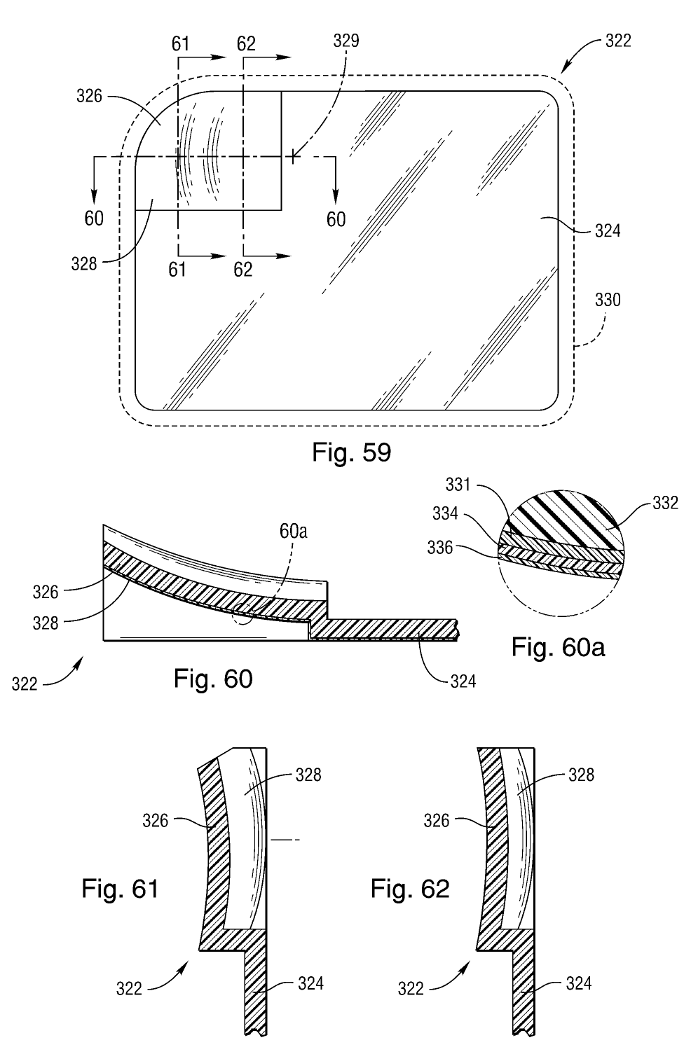

Another method for employing an integrally formed mirror that encompasses the teachings of this invention provides a structure that can be either a first surface mirror or a second surface mirror molded from plastic. FIGS. 59, 60, 60a, 61, 62 and 63 will first describe how this structure can be a unitary first surface plastic mirror. In addition, FIGS. 64, 65 and 66 will depict how the structure can be a unitary second surface plastic mirror. In both arrangements, it is desirable to apply a layer of hardcoat material, such as a siloxane, to the unitary plastic mirror surface to provide the reflective coating with scratch resistance.

FIG. 59 is a front view of an automotive outside rearview mirror 322 wherein a plane main viewing portion 324 is integrally formed with an auxiliary blindzone viewing portion 326. The entire front surface of the mirror 322 is coated with a reflective material, including a convex surface 328, making mirror 322 a first surface mirror. Preferably, the mirror 322 in this first surface arrangement is comprised of an opaque plastic material. An opaque filled plastic typically has better dimensional qualities than a transparent plastic when molded. However, it is fully contemplated that transparent plastic material can be substituted for opaque plastic in this embodiment. Various types of opaque plastic material can be used. One such example is polyphenylene sulfide, a pure thermoplastic. Another such example is GE's Thermoset Noryl, which is a thermoset and thermoplastic combination. Yet another such example could be a thermoset bulk molding compound.

Depending on the properties of the plastic used to mold the unitary rear view mirror 322, distortion may occur near the outside edges of mirror 322. Shrink, sink, and warpage of the plastic material during the injection molding process can cause this distortion. Edge distortion is typically more frequent in transparent plastics, but can occur with opaque plastics as well. It may be desirable to mold an oversize mirror 330 and trim it down to size to remove the uneven edges causing the distortion. For example, laser trimming the oversize mirror 330 would provide, clean edges devoid of distortion. FIG. 59 shows an outline of the shape of the oversize mirror 330 prior to trimming it into mirror 322.

A point 329 on the surface of the mirror 322 depicts the point where a radius extends from the center of the sphere defining the convex surface 328, and said radius orthogonally intersects the plane of the main viewing portion 324. The point 329 is typically adjacent to the inboard edge of the blindzone viewing mirror 326.

FIG. 60 is an enlarged top sectional view of mirror 322 taken along section line 60-60 primarily showing the convex surface 328 of the blindzone viewing portion 326. The blindzone viewing portion 326 in this embodiment is fully recessed such that no portion of the convex surface 328 extends in front of the first surface plane of the main viewing portion 324. FIG. 60a is an enlarged view of the first surface of mirror 322. A primary hardcoat layer 331 may be applied directly to the plastic surface 332 of mirror 322. The reflective coating 334 is then applied atop the primary hardcoat layer 331. Further, an additional hardcoat layer 336 is then applied atop the reflective coating 334, particularly if an aluminum reflective coating is used since it is not as adherent as chromium. However, the invention contemplates applying a reflective coating directly to the plastic surface followed by a layer of hardcoat material. Within the scope of the invention, any combination of reflective coatings and layers of hardcoat material may be utilized.

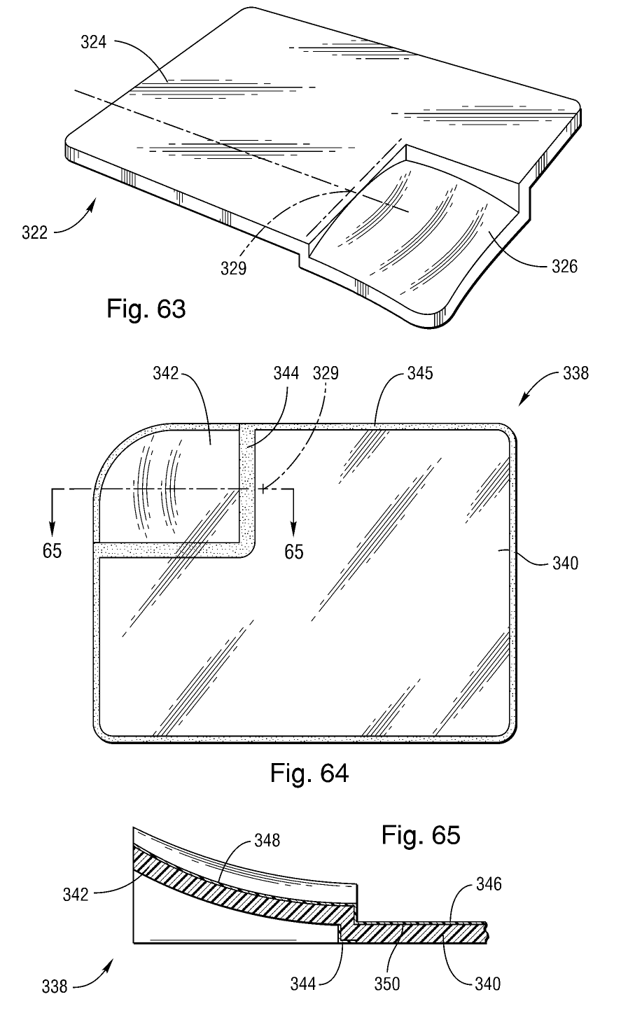

FIGS. 61 and 62 are enlarged side sectional views of mirror 322 primarily showing the convex surface 328 of the blindzone viewing portion 326. In FIG. 61, the section line cuts through the blindzone viewing portion 326 of mirror 322 near the outer most edge of mirror 322. In FIG. 62, a similar section line is taken further inward than that of FIG. 61. Both Figures help to illustrate the form of the blindzone viewing portion 326 of mirror 322. With reference now to FIG. 63 is a perspective view of mirror 322. In this view, mirror 322 is rotated to show the form of the blindzone viewing portion 326.

As previously mentioned, an alternative embodiment to the unitary rearview mirror 322 provides a second surface mirror formed from plastic material. In this embodiment, the outside rearview mirror is necessarily comprised of a transparent plastic material. Various types of transparent plastic material can be used. One such example is a polycarbonate. Another such example is a polycarbonate alloy, such as polycarbonate and ABS, or the like. Referring now to FIG. 64, a front view of an automotive outside rearview mirror 338, wherein a plane main viewing portion 340 is integrally formed with an auxiliary blindzone viewing portion 342 is illustrated. It is noted that the mirror 338 is formed from the same or similar mold as that of mirror 322.

In addition, it may be desirable for mirror 338 to have an inner non-reflective mask 344 providing a frame that encompasses the blindzone viewing portion 342. The edges of transition from the main viewing portion 340 to the blindzone viewing portion 342 may cause a slight visible distortion in the reflection of the transparent mirror 338. The distortion is the result of light rays bending in various directions due to refraction caused by the transparent material between the reflective surface and the first surface. The inner non-reflective mask 344 will eliminate these visible distortions. One such way of providing an inner non-reflective mask 344 is to create a matte finish in the appropriate section of the mold. As a result, the matte finish of the mold translates to a matte finish in the region of the inner non-reflective mask 344 making said region non-reflective. An alternative method to providing an inner non-reflective mask 344 is to apply a non-reflective coating in the region of the non-reflective mask 344 (e.g., a painted frame).

As previously mentioned, distortion may occur at the outside edges of mirror 338, especially in mirrors formed from transparent plastics. A method of molding a unitary plastic mirror oversized, and laser trimming the excess was previously discussed. FIG. 64 shows an alternative method to eliminate distracting edge distortion. This alternative method includes generating an outer non-reflective mask 345 that frames the entire mirror 338. The outer non-reflective mask 345 would eliminate distortions at the outer edges of mirror 338 similar to how the inner non-reflective mask 344 eliminates reflective distortions.

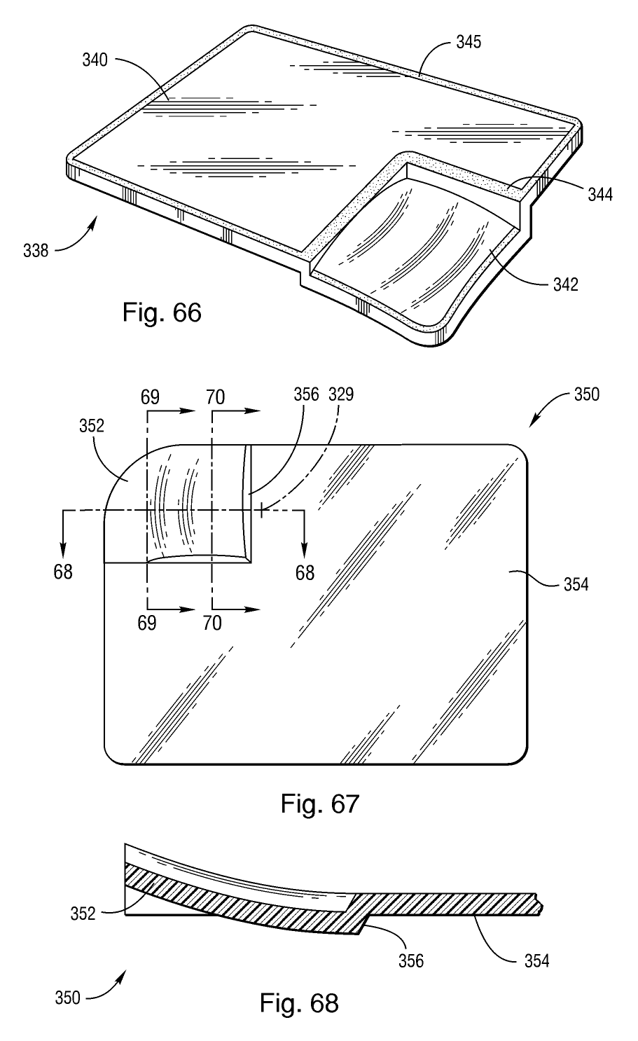

The inner non-reflective mask 344 is also shown in the enlarged top sectional view of mirror 338 in FIG. 65. The entire back surface 346 of mirror 338 is coated with a reflective material including concave surface 348 making mirror 338 a second surface mirror. A similar arrangement of the reflective material being located intermediate to two hardcoat layers, as in FIG. 60a, may also be applied to the back surface 346 of mirror 338. Within the scope of the invention, any combination of reflective coatings and layers of hardcoat material may be utilized. FIG. 66 is a perspective view of mirror 338 rotated in such a way that it shows the form of mirror 338.

In the first two embodiments of the plastic integral mirrors 322 and 338, the auxiliary blindzone viewing mirror is fully recessed behind the plane of the front surface of the main viewing mirror. This configuration provides an unobtrusive look to the mirror while still incorporating all the optical characteristics defined by the teachings of this invention.

In FIGS. 67, 68, 69, 70 and 71, an alternative outside rearview mirror 350 is shown wherein the auxiliary blindzone viewing portion 352 is only partially recessed behind the plane of the front surface of the plane main viewing portion 354. The advantage this configuration provides is that the overall thickness of the plastic integral mirror 350 is reduced.

In FIG. 67, it can be seen that the mirror 350 is very similar to mirrors 322 and 338. However, because the blindzone viewing portion 352 of mirror 350 is only partially recessed, an inboard marginal edge 356 is created. In the enlarged top sectional view of FIG. 68, the inboard marginal edge 356 is canted.

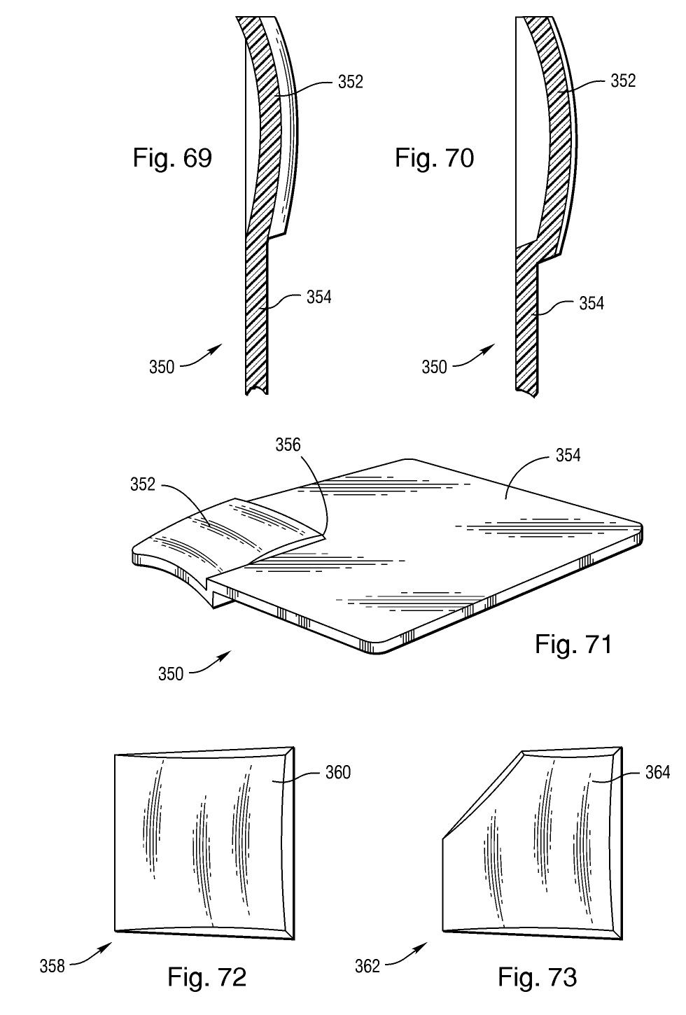

FIGS. 69 and 70 are additional sectional views of mirror 350, taken along their respective section lines, that help show the partially recessed blindzone viewing portion 352. FIG. 71 is a perspective view of mirror 350 that also aids in describing the form of mirror 350.

Although not specifically shown, it is fully contemplated that the embodiment of mirror 350 can be either a first surface opaque mirror similar to mirror 322, or a second surface transparent mirror similar to mirror 338. In either event, the mirror 350 maintains all of the same optical characteristics of mirrors 322 and 338, including a blindzone viewing portion 352 located in the upper outer quadrant of the mirror 350 wherein the blindzone viewing portion 352 detects an object primarily only in the vehicle's blindzone.

There are many advantages of having a unitary plastic mirror body encompassing both a plane main viewing mirror and an auxiliary blindzone viewing mirror. As previously mentioned, the need for an adhesive is eliminated and the mirror is reduced to a single component. In addition, the plastic integral mirror is cost effective. Further, the plastic integral mirror could be shatterproof, preventing the mirror body from breaking during assembly or thereafter.

Returning to FIG. 5, the idea of a stick-on blindzone viewing mirror adhered to a plane outside rearview mirror is first mentioned. Next, various embodiments of this stick-on mirror concept wherein the stick-on blindzone mirror is a plastic segment of a spherically convex mirror will be shown. Note, however the stick-on blindzone mirror is intended to show primarily only the vehicle blindzone as is consistent with the teachings of this invention.

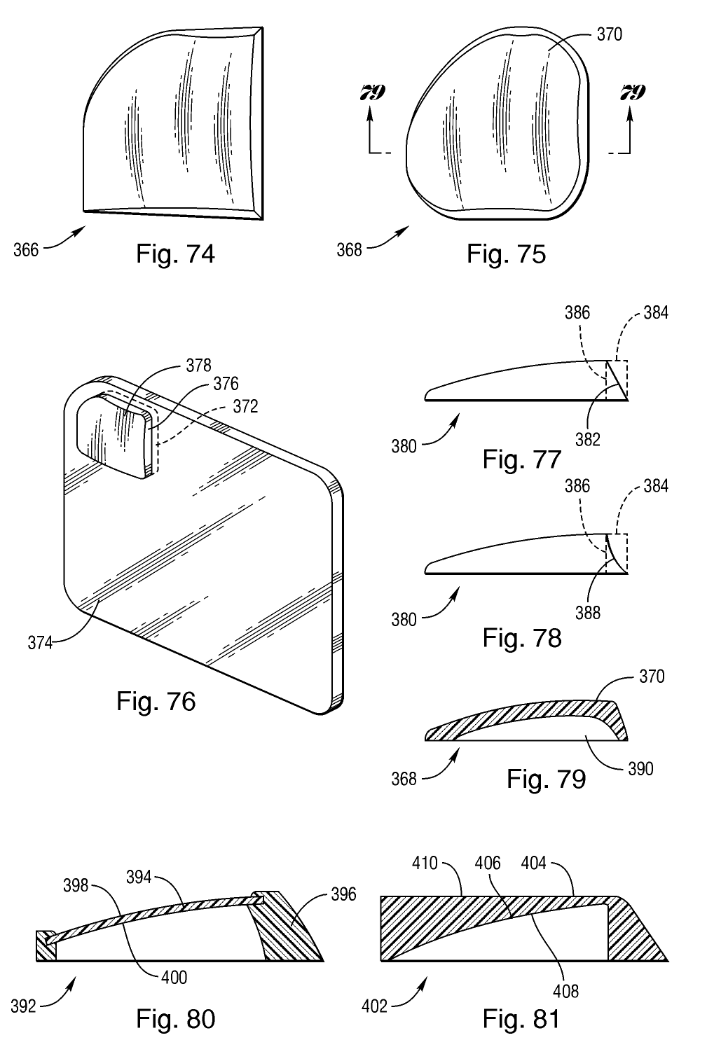

A stick-on mirror can be generated from a number of different shapes and sizes. In FIG. 72, the general shape of a stick-on mirror 358 is square and has a convex surface 360. However, it is desirable to have a stick-on mirror designed to mount in the upper and outer quadrant of a main outside rearview mirror. This can be accomplished by truncating the upper and outer corner of a stick-on mirror 362 without compromising the optical characteristics provided by a convex surface 364, as shown in FIG. 73. Further, FIG. 74 shows a stick-on mirror 366 wherein the truncated corner is rounded to allow it to be moved further into the upper and outer corner as well as for aesthetic purposes. Since the upper and outer region of the typical outside rearview mirror is generally curved, mirrors 362 and 366 can be more effectively located in the corner of this region of the typical outside rearview mirror. The advantage of mirrors 362 and 366 is that they provide a more efficient use of space on the surface of the outside rearview mirror. The truncated corner of the stick-on mirror 366 can even be contoured to fit precisely in the upper and outer corner of a given outside rearview mirror.

In the preferred embodiment of a stick-on blindzone mirror, all of the corners of the stick-on mirror are rounded for aesthetic appeal. In FIG. 75, a stick-on mirror 368 depicts such an auxiliary blindzone viewing mirror. The mirror 368 provides the advantages of the previously mentioned stick-on mirrors without compromising the visual performance of the convex surface 370. The stick-on mirror 368 is designed to be located in the upper and outer quadrant of an outside rearview mirror in accordance with FMVSS 111. Additionally, the natural flow of an image across an outside rearview mirror is from the inside to outside. When a passing vehicle moves into the driver's blindzone it is desirable that the passing vehicle's image remains at the rearview mirrors outer edge rather then jumping to an alternate location.

The inboard edge of a stick-on mirror nearest the driver is ideally shaped in such a way that the reflection of this edge is invisible in the main outside rearview mirror when viewed from the driver's perspective. If the inboard edge of the stick-on mirror is not shaped in such a way, then the impression of the thickness of the inboard edge of the stick-on mirror would double in size due to its reflection in the main mirror.

FIG. 76 is a perspective view from the driver's angle showing how a reflection 372 in the main viewing mirror 374 of an inboard edge 376 of a stick-on mirror 378 can result in a visual distraction. For example, if the inboard edge 376 were 0.25 inches thick, the driver would see the reflection 372 in the main mirror 374 giving the impression of a 0.5 inch thick stick-on mirror 378.

The reflection can be eliminated by providing an inboard marginal edge of the blindzone viewing mirror that is canted, as previously mentioned with reference to mirror 350. The canted edge can be thought of as a skirt around the stick-on mirror. FIG. 77 is a side view of a stick-on mirror 380 having a canted inboard marginal edge 382, wherein the canted edge 382 is a straight edge and is defined by a base 384 and a height 386. The base 384 is ideally greater than or equal to half the height 386 of mirror 380 to sufficiently eliminate the offending reflection in the main rearview mirror.

Alternatively, the canted edge does not have to be a straight edge. FIG. 78 shows another example of a canted edge for eliminating the edges reflection in a main viewing mirror. Note that like elements use like reference numbers however new elements are assigned new reference numbers. In this embodiment, the stick-on mirror 380 has a canted inboard marginal edge 388 wherein the canted edge 388 is a curved edge and is defined by the base 384 and the height 386. As in the previous example, it is ideal that the base 384 be greater than or equal to half the height 386 of the stick-on mirror 380. It is important to note that this criterion is a function of the driver's location relative to the main viewing mirror and applies generally over the range of positions found in practice. Also, it is fully contemplated that the concept of the canted edge can apply to a partially recessed integrally formed mirror, such as mirror 350.

Aside from its general shape, a stick-on mirror can have various configurations in which it is employed. One such configuration is depicted in FIG. 79. FIG. 79 is a side sectional view of mirror 368 taken along section line 79-79. In this embodiment, mirror 368 is a single piece molding having a convex first surface 370. The mirror 368 could be formed from an opaque plastic providing a high quality surface. As previously mentioned, it may be desirable to apply a hardcoat to the plastic convex surface 370 for scratch resistance. It is also reasonable to apply hardcoat layers, as shown in FIG. 60a, wherein the reflective coating is located intermediate two layers of hardcoat material. Additionally, the mirror 368 can have a hollowed out region 390 for the purpose of overall weight reduction of the mirror 368 and uniform thickness.

Another configuration of a stick-on mirror is shown in FIG. 80. A stick-on mirror 392 comprises a convex second surface parallel plate mirror 394 mounted in a plastic housing 396. The parallel plate mirror 394 could be either glass or plastic. If plastic, a hardcoat is applied to the first surface 398 and a reflective coating is applied to the second surface 400. This embodiment is similar in construction to prior art stick-on mirrors, but it is specifically designed to show primarily only the vehicle's blindzone and it is designed to mount in the upper and outer quadrant of the mirror to which it is adhered.

Yet another configuration utilizes a second surface mirror formed from a single piece molding. FIG. 81 depicts a solid segment second surface stick-on mirror 402 having a planar first surface 404 and a convex second surface 406. A reflective coating 408 is applied to the second surface 406 making it a second surface mirror. The mirror 402 is formed from a transparent plastic material such as a polycarbonate, or the like. It may be desirable for the planar first surface 404 to be coated with an anti-reflective material 410 to reduce first surface reflections. Since the reflective intensity would differ between the first surface and the second surface, an undesirable application of light could produce ghost images from the first surface reflection over top the actual desired images from the second surface reflection. Though this ghosting is not severe, it is preferred to provide anti-reflective material 410 to the plane first surface 404 to reduce the first surface reflections. One particular advantage of mirror 402 is that the material between the plane first surface 404 and the convex second surface 406 produces refraction that allows the height of the mirror to be reduced.

The invention in its broader aspects is not limited to the specific details shown and described, and departures may be made from such details without departing from the principles of the invention and without sacrificing its advantages. For example, the present invention can be applied in other applications such as heavy off-road vehicles and the like where a clear unobstructed wide field of view is required for safe operation, and yet the size of the mirror must be limited.

1-14. (canceled)

15. An outside rearview mirror for automotive vehicle applications comprising:
a mirror body comprising:
a main rearview mirror including a first light-transmitting substrate having a first surface and a second surface, said main rearview mirror comprising one of (i) a first surface mirror having reflective material coated at said first surface of said first light-transmitting substrate and (ii) a second surface mirror having reflective material coated at said second surface of said first light-transmitting substrate; and
an auxiliary blindzone-viewing mirror disposed at the rear of said second surface of said first light-transmitting substrate of said main rearview mirror and viewable through a region of said main rearview mirror which is devoid of reflective material, wherein no portion of said auxiliary blindzone-viewing mirror contacts said first surface of said first light-transmitting substrate of said main rearview mirror, said auxiliary blindzone-viewing mirror being located behind an upper and outer quadrant of said main rearview mirror;
said auxiliary blindzone-viewing mirror including a second light-transmitting substrate having a light-transmitting generally planar face and an opposing light-reflecting curved face, wherein light incident on said first surface of said first light-transmitting substrate in the region devoid of reflective material passes through said first light-transmitting substrate and said planar face of the second light-transmitting substrate to be reflected off said light-reflecting curved face, said light-reflecting curved face of said auxiliary blindzone-viewing mirror having a radius of curvature and characteristic magnification less than that of said main rearview mirror; and
said auxiliary blindzone-viewing mirror providing a wide angle view of a blind spot to a side of a vehicle and said main rearview mirror providing a view rearward of the vehicle when said mirror body is mounted in an outside rearview mirror assembly on the side of the vehicle and is normally viewed by a driver of the vehicle when operating the vehicle.

16. The outside rearview mirror of claim 15, wherein the characteristic reflectivity of said auxiliary blindzone-viewing mirror is greater than the characteristic reflectivity of said main rearview mirror.

17. The outside rearview mirror of claim 16, wherein said first light-transmitting substrate of said main rearview mirror comprises:
a light-transmitting glass substrate, wherein said planar face of said auxiliary blindzone-viewing mirror is adhered to said second surface of said light-transmitting glass substrate of said main rearview mirror by a clear adhesive having an index of refraction near that of glass.

18. The outside rearview mirror of claim 17, wherein said light-transmitting glass substrate of the main rearview mirror comprises a planar glass substrate having a generally unit characteristic magnification associated with a region coated with reflective material.

19. The outside rearview mirror of claim 18, wherein said light-reflecting curved face of said auxiliary blindzone-viewing mirror comprises a convex-curved face that is metallized with a metallic reflective coating.

20. The outside rearview mirror of claim 19, wherein said convex-curved face comprises a spherical convex-curved shape.

21. The outside rearview mirror of claim 19, wherein the radius of curvature of said convex-curved face is in the range of about 20 cm multiplied by the refractive index of said second light-transmitting substrate of said auxiliary blindzone-viewing mirror to about 35 cm multiplied by the refractive index of said second light-transmitting substrate of said auxiliary blindzone-viewing mirror.

22. The outside rearview mirror of claim 21, wherein a viewing angle of said auxiliary blindzone-viewing mirror primarily encompasses a region between an outer limit of a viewing angle of said main rearview mirror and a rearward limit of the driver's peripheral vision when said driver is viewing said mirror body when normally operating the vehicle.

23. An outside rearview mirror for automotive vehicle applications comprising:
a mirror body having a main rearview mirror and an auxiliary blindzone-viewing mirror, said main rearview mirror comprising:
a front light-transmitting glass substrate having a first surface and a second surface; and
a rear substrate having a third surface and a fourth surface, wherein said second surface of said front light-transmitting glass substrate and said third surface of said rear substrate are joined and spaced apart by a perimeter seal forming a chamber therebetween;
an electro-optic medium disposed in said chamber; and
a main mirror reflector comprising reflective material disposed at said rear substrate;
said auxiliary blindzone-viewing mirror disposed rearward of said second surface of said front light-transmitting glass substrate of said main rearview mirror and viewable through a region of said main rearview mirror which is devoid of reflective material;
said auxiliary blindzone-viewing mirror being located behind an upper and outer quadrant of said main rearview mirror when said mirror body is mounted in an outside rearview mirror assembly on a side of a vehicle, wherein no portion of said auxiliary blindzone-viewing mirror is in contact with said first surface of said front light-transmitting glass substrate of said main mirror reflector;
said auxiliary blindzone-viewing mirror comprising a light-transmitting substrate including:
a light-transmitting generally planar face; and
an opposing light-reflecting curved face having a radius of curvature and characteristic magnification less than that of said main rearview mirror, wherein light incident on said first surface of said front light-transmitting glass substrate of said main rearview mirror passes through said front light-transmitting glass substrate and said planar face to be reflected off said light-reflecting curved face;
said auxiliary blindzone-viewing mirror providing a wide angle view of a blind spot to the side of the vehicle and said main rearview mirror providing a view rearward of the vehicle when said mirror body is mounted in the outside rearview mirror assembly and is normally viewed by a driver of the vehicle when operating the vehicle.

24. The outside rearview mirror of claim 23, wherein said light-transmitting planar face of said auxiliary blindzone-viewing mirror is adhered to said main rearview mirror by a clear adhesive having an index of refraction near that of glass.

25. The outside rearview mirror of claim 23, wherein said light-transmitting planar face of said auxiliary blindzone-viewing mirror is adhered to said main rearview mirror at one of (i) said second surface of said front light-transmitting glass substrate and (ii) said fourth surface of said rear substrate.

26. The outside rearview mirror of claim 23, wherein said light-transmitting planar face of said auxiliary blindzone-viewing mirror is adhered to said main rearview mirror at said second surface of said front light-transmitting glass substrate, said front light-transmitting glass substrate comprising a planar glass substrate, wherein reflection off said main rearview mirror is of generally unit characteristic magnification.

27. The outside rearview mirror of claim 26, wherein said light-reflecting curved face of said auxiliary blindzone-viewing mirror comprises a convex-curved face that is metallized with a metallic reflective coating.

28. The outside rearview mirror of claim 27, wherein said convex-curved face comprises a spherical convex-curved shape.

29. The outside rearview mirror of claim 27, wherein said convex-curved face has a radius of curvature in the range of about 20 cm multiplied by the refractive index of the light-transmitting substrate of said auxiliary blindzone-viewing mirror to about 35 cm multiplied by the refractive index of the light-transmitting substrate of said auxiliary blindzone-viewing mirror.

30. The outside rearview mirror of claim 23, wherein a viewing angle of said auxiliary blindzone-viewing mirror primarily encompasses a region between an outer limit of a viewing angle of said main rearview mirror and a rearward limit of the driver's peripheral vision when said driver is viewing said mirror body when normally operating the vehicle.

31. The outside rearview mirror of claim 30, wherein the characteristic reflectivity of said auxiliary blindzone-viewing mirror is greater than the characteristic reflectivity of said main rearview mirror.

32. An outside rearview mirror for automotive vehicle applications comprising:
a mirror body having a main rearview mirror and an auxiliary blindzone-viewing mirror, said main rearview mirror comprising a front light-transmitting planar substrate having a first surface and a second surface and a rear planar substrate having a third surface and a fourth surface, said second surface of said front light-transmitting planar substrate and said third surface of said rear substrate joined and spaced apart by a perimeter seal forming a chamber therebetween, wherein no portion of said auxiliary blindzone-viewing mirror is in contact with said first surface of said front light-transmitting planar substrate of said main rearview mirror;
an electrochromic medium disposed in said chamber; and
a main mirror reflector comprising reflective material disposed at said rear substrate, wherein reflection off said main mirror reflector of said main rearview mirror is of generally unit characteristic magnification;
wherein said auxiliary blindzone-viewing mirror is disposed rearward of said second surface of said front light-transmitting planar substrate of said main rearview mirror and viewable through a region of said main rearview mirror which is devoid of reflective material, wherein said auxiliary blindzone-viewing mirror is located behind an upper and outer quadrant of said main rearview mirror when said mirror body is mounted in an outside rearview mirror assembly on a side of a vehicle;
said auxiliary blindzone-viewing mirror comprising a light-transmitting substrate having a light-transmitting generally planar face and an opposing light-reflecting curved face having a radius of curvature and characteristic magnification less than that of said main rearview mirror, wherein light incident on said first surface of said front light-transmitting planar substrate of said main rearview mirror passes through said front light-transmitting planar substrate and said light-transmitting planar face to be reflected off said light-reflecting curved face;
said auxiliary blindzone-viewing mirror providing a wide angle view of a blind spot to the side of the vehicle and said main rearview mirror providing a view rearward of the vehicle when said mirror body is mounted in the outside rearview mirror assembly on the side of the vehicle and is normally viewed by a driver of the vehicle when operating the vehicle; and
wherein said planar face of said auxiliary blindzone-viewing mirror is adhered to said main rearview mirror at said second surface of said front light-transmitting planar substrate at a location lateral of said perimeter seal and outside said chamber so that when an electrical voltage is applied to said electrochromic medium to reduce the reflectance of said main rearview mirror, reflectance of light by said auxiliary blindzone-viewing mirror is unaffected.

33. The outside rearview mirror of claim 32, wherein said rear substrate is notched where said auxiliary blindzone-viewing mirror is disposed to the rear of said front light-transmitting planar substrate.

34. The outside rearview mirror of claim 33, wherein said front light-transmitting planar substrate of said main rearview mirror comprises a glass substrate, wherein said light-transmitting planar face of said auxiliary blindzone-viewing mirror is adhered to said second surface of said front light-transmitting planar substrate of said main rearview mirror by a clear adhesive having an index of refraction near that of glass.

35. The outside rearview mirror of claim 34, wherein said light-reflecting curved face of said auxiliary blindzone-viewing mirror comprises a convex-curved face that is metallized with a metallic reflective coating.

36. The outside rearview mirror of claim 35, wherein said convex-curved face has a radius of curvature in the range of about 20 cm multiplied by the refractive index of the light-transmitting substrate of said auxiliary blindzone-viewing mirror to about 35 cm multiplied by the refractive index of the light-transmitting substrate of said auxiliary blindzone-viewing mirror.

37. The outside rearview mirror of claim 32, wherein a viewing angle of said auxiliary blindzone-viewing mirror primarily encompasses a region between an outer limit of a viewing angle of said main rearview mirror and a rearward limit of the driver's peripheral vision when said driver is viewing said mirror body when normally operating the vehicle.

38. The outside rearview mirror of claim 37, wherein the characteristic reflectivity of said auxiliary blindzone-viewing mirror is greater than the characteristic reflectivity of said main rearview mirror.
